(19) United States
(12) Patent Application Publication
(10) Pub. No.: US 2016/0196049 A1
(43) Pub. Date: Jul. 7, 2016

(54) INFORMATION PROCESSING DEVICE, CONTROL METHOD FOR INFORMATION PROCESSING DEVICE, AND RECORDING MEDIUM

(71) Applicant: SHARP KABUSHIKI KAISHA, Osaka-shi, Osaka (JP)

(72) Inventors: Hiroyasu IWATSUKI, Osaka-shi (JP); Akiyoshi SATOH, Osaka-shi (JP)

(21) Appl. No.: 14/915,701

(22) PCT Filed: Sep. 2, 2014
(86) PCT No.: PCT/JP2014/073089

§ 371 Date: Mar. 1, 2016

(30) Foreign Application Priority Data
Sep. 4, 2013 (JP) 2013-183431

(51) Int. Cl. G06F 3/0484; G06F 7/08; G06F 3/0482

(52) U.S. Cl. CPC G06F 3/04845; G06F 3/0482; G06F 7/08

(57) ABSTRACT

The information processing device includes (i) a superimposed display processing section for causing a superimposed object (C) to be displayed so that the superimposed object (C) is superimposed on the content, and (ii) a background tying section for causing notification information (E, D) to be displayed in a state where the superimposed object is temporarily hidden. The notification information (E, D) is indicative of a position of a range specified on the content for displaying the superimposed object.

### TECHNICAL FIELD

The present invention relates to an information processing device for use in browsing content.

### BACKGROUND ART

A user interface for comfortably browsing a web page has conventionally been developed. For example, a browser capable of displaying a plurality of web pages by switching tabs has been developed and widely used.

A user interface for more comfortably using an information processing device has also been developed. For example, a technique disclosed in Patent Literature 1 makes it possible to comfortably carry out, in an information processing device including a touch panel, a touch operation by (i) enlarging an image of an operation position at which the touch operation has been carried out and (ii) displaying the enlarged image so that the enlarged image is superimposed on the operation position. Meanwhile, a technique disclosed in Patent Literature 2 allows an image of a region specified as a copy or movement target to be copied or moved by displaying the image of the region as a selected object and moving the selected object to a desired page.

### CITATION LIST

### Patent Literature

[Patent Literature 1]

Japanese Patent Application Publication “Tokukai No. 2012-043452” (Publication date: Mar. 1, 2012)

[Patent Literature 2]

Japanese Patent Application Publication “Tokukai No. 2012-088807” (Publication date: May 10, 2012)

### SUMMARY OF INVENTION

### Technical Problem

Note here that pieces of information on which a user focuses are frequently scattered in a single web page, which typically contains various pieces of information. In a case where a web page is displayed by a conventional browser, a user needs to turn eyes thereof on different positions on a display screen so as to browse pieces of information on which the user focuses. In a case where the pieces of information are not displayed on a single screen, the user needs to repeatedly scroll-display the web page.

As a method for solving such a problem, a method may be employed in which a superimposed object which (i) contains an image in a range specified on content displayed on a display screen and (ii) is movable on the display screen is displayed so that the superimposed object is superimposed on the content. In this method, the content is partially hidden by the superimposed object, and it is therefore preferable to temporarily hide the superimposed object in order to secure viewability of the content.

However, in a case where the superimposed object is hidden, a user cannot know whether (i) the superimposed object is temporarily hidden but can be displayed again or (ii) the superimposed object cannot be displayed again. Moreover, after the superimposed object is hidden, the user may forget which position of the content the hidden superimposed object was displayed. This may cause a situation in which, even though the superimposed object can be displayed again, the user carries out an unnecessary process of newly displaying a superimposed object by specifying a range again.

The present invention is accomplished in view of the problem, and its object is to provide an information processing device and the like which enable a user to recognize which position of content an existing superimposed object corresponds to, in a state where the superimposed object which has been displayed while being superimposed on the content is temporarily hidden.

### Solution to Problem

In order to attain the object, an information processing device in accordance with an aspect of the present invention is an information processing device for displaying content, the information processing device including: a superimposed displaying section for causing a superimposed object to be displayed so that the superimposed object is superimposed on the content, the superimposed object containing an image in a range specified on the content which is displayed; and an information displaying section for causing notification information to be displayed in a state where the superimposed object is temporarily hidden, the notification information being indicative of a position of the range on the content.

### Advantageous Effects of Invention

According to an aspect of the present invention, it is possible to bring about an effect of enabling a user to recognize which position of content an existing superimposed object corresponds to, in a state where the superimposed object is temporarily hidden.

### BRIEF DESCRIPTION OF DRAWINGS

FIG. 1 is a block diagram showing an example of a configuration of a substantial part of an information processing device in accordance with an embodiment of the present invention.

FIG. 2 illustrates how a superimposed display is carried out by the information processing device. (a) of FIG. 2 shows an example of a screen in which a range is specified. (b) of FIG. 2 shows an example of the screen in which an image of the range specified in (a) of FIG. 2 is displayed so as to be superimposed on a web page.

FIG. 3 illustrates a display aspect in which a superimposed object is hidden in the information processing device. (a) of FIG. 3 shows an aspect of out-of-screen dragging which is an operation to drag a superimposed object to an outside of the display screen. (b) of FIG. 3 shows an example of a screen in which a string image is displayed during a non-display state of the superimposed object.

FIG. 4 illustrates an example of a screen during a state where superimposed objects are tied to each other.

FIG. 5 illustrates, in (a) and (b), an example of an operation which is carried out by a user to tie superimposed objects to each other.

FIG. 6 is a view relating to screen-capturing of a tied superimposed object. (a) of FIG. 6 shows an example of an operation for carrying out screen-capturing. (b) of FIG. 6 shows an example of a captured image.

FIG. 7 is a view relating to copying of a tied superimposed object. (a) of FIG. 7 shows an example of an operation for carrying out copying. (b) of FIG. 7 shows an example of a copied text. (c) of FIG. 7 shows an example of a text copied by tying.

FIG. 8 is a view relating to priority setting of tied superimposed objects. (a) of FIG. 8 shows an example of an operation for carrying out priority setting. (b) of FIG. 8 shows an example of a screen after a priority is set.

FIG. 9 shows an example of sorting tied superimposed objects. (a) of FIG. 9 shows an example of an operation for carrying out sorting. (b) of FIG. 9 shows an example of a screen after sorting.

FIG. 10 is a view relating to keyword display of a superimposed object. (a) of FIG. 10 shows an example of an operation for carrying out switching between detail display and keyword display. (b) of FIG. 10 shows an example of a superimposed object in a keyword display state.

FIG. 11 illustrates an example of switching to keyword display of a superimposed object. (a) of FIG. 11 shows an example of an operation for carrying out switching between detail display and keyword display. (b) of FIG. 11 shows an example of a screen after switching to keyword display.

FIG. 12 shows a specific example of a background layer management table.

FIG. 13 shows a specific example of a superimposed layer management table.

FIG. 14 shows a specific example of a priority list table.

FIG. 15 illustrates a map. (a) of FIG. 15 shows an example of setting of the map. (b) of FIG. 15 shows an example of a layer display in accordance with the map illustrated in (a) of FIG. 15.

FIG. 16 shows an example of how to specify, in accordance with reference coordinates, a touch position in a superimposed layer.

FIG. 17 is a flow chart showing an example of an object display process.

FIG. 18 is a flow chart showing an example of a superimposition setting process.

FIG. 19 is a flow chart showing an example of a display update process.

FIG. 20 is a flow chart showing an example of a touch operation handling process.

FIG. 21 is a flow chart showing a first half of an example of a two-finger touch operation handling process.

FIG. 22 is a flow chart showing a second half of an example of a two-finger touch operation handling process.

FIG. 23 is a flow chart showing an example of an out-of-screen dragging process.

FIG. 24 is a flow chart showing an example of an attribute changing process.

FIG. 25 is a flow chart showing an example of a layer-to-layer tying process.

FIG. 26 is a flow chart showing an example of a string image setting/cancelling process.

FIG. 27 is a flow chart showing an example of a keyword display process.

FIG. 28 is a flow chart showing an example of a keyword obtaining process.

FIG. 29 is a flow chart showing an example of a detail display process.

FIG. 30 is a flow chart showing an example of a priority setting process.

FIG. 31 is a flow chart showing an example of a sorting process.

FIG. 32 is a flow chart showing an example of a tied layer deleting process.

### DESCRIPTION OF EMBODIMENTS

### Embodiment 1

An information processing device 1 in accordance with Embodiment 1 is a device having a browser function of displaying a web page. The information processing device 1 enlarges and displays an image of a range so that the image is superimposed on the web page, the range having been specified in the displayed web page. Note that a web page refers to content on a network and a set of data displayed at one time by a browser.

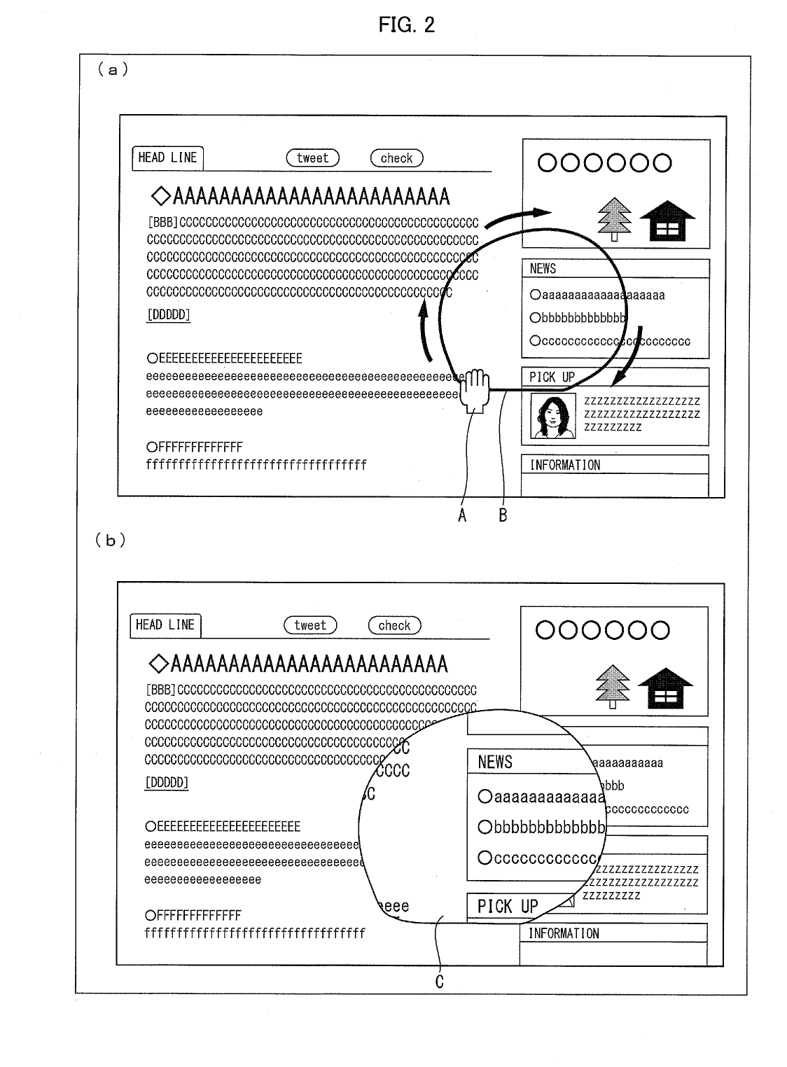

The following description discusses, with reference to FIG. 2, a display on the information processing device 1. FIG. 2 illustrates how a superimposed display is carried out. (a) of FIG. 2 shows an example of a screen in which a range is specified. (b) of FIG. 2 shows an example of the screen in which an image of the range specified in (a) of FIG. 2 is displayed so as to be superimposed on a web page.

(a) of FIG. 2 illustrates a state in which a range surrounded by a line B is specified by moving a cursor A on a displayed web page. When the range has been specified, the information processing device 1 displays, as illustrated in (b) of FIG. 2, an image of the specified range so that the image is superimposed on an original web page which is originally displayed. Such an image that is displayed so as to be superimposed on the original web page is hereinafter referred to as a superimposed object. A superimposed object C illustrated in (b) of FIG. 2 includes an enlarged image of the specified range. That is, the superimposed object C is an object including an image of the range (i.e., the range surrounded by the line B) which has been specified on the displayed web page (content).

The superimposed object C operates separately from the original web page. Further, the superimposed object C can be moved to any position on a display screen. Note that, in a case where a double-tap operation (an operation to touch a display screen for a short time period two consecutive times) is carried out with respect to the superimposed object C, the information processing device 1 full-screen displays a web page corresponding to the superimposed object C (the original web page in the example of (b) of FIG. 2).

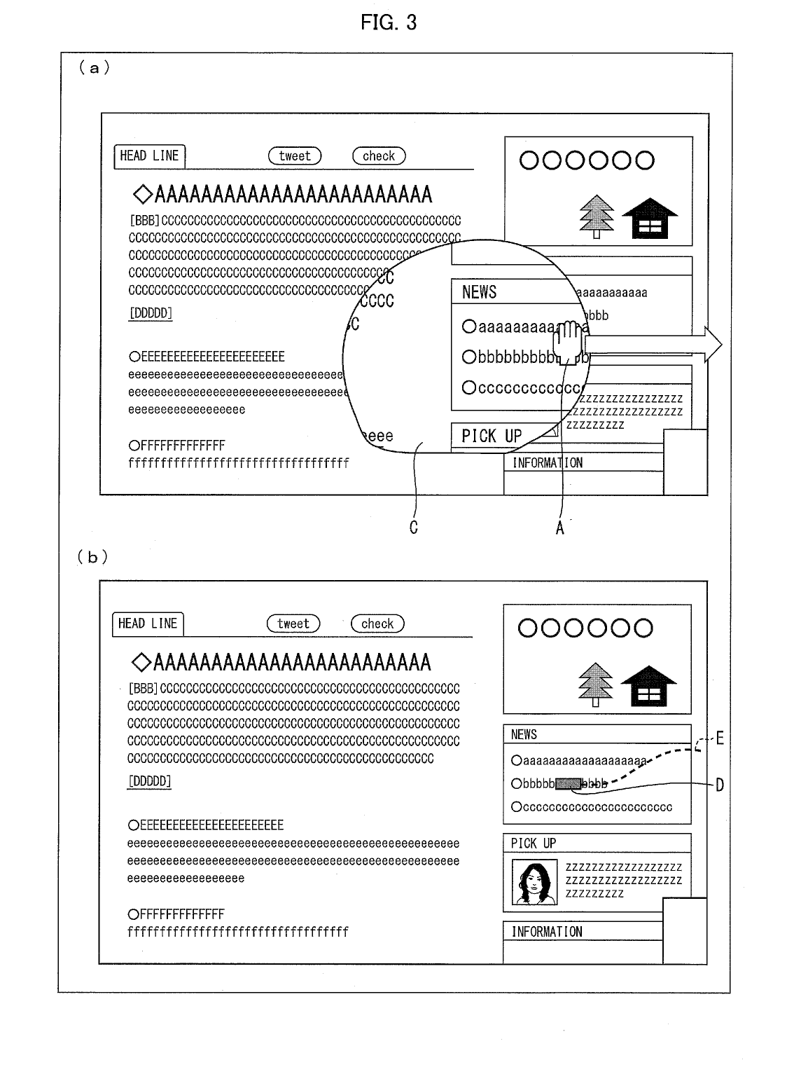

Next, the following description discusses an operation for causing a superimposed object to be temporarily in a non-display state, with reference to FIG. 3. (a) of FIG. 3 shows that out-of-screen dragging which is an operation to drag a superimposed object C to an outside of the display screen is carried out. (b) of FIG. 3 shows an example of a screen in which a string image E is displayed during a non-display state of the superimposed object C.

As illustrated in (a) of FIG. 3, in a case where an operation to drag the superimposed object C to an outside of the display screen is carried out while the cursor A is on the superimposed object C, the information processing device 1 then causes a string image E to be displayed instead of the superimposed object C, as illustrated in (b) of FIG. 3. This allows the presence of the superimposed object C, which is in the non-display state, to be visually indicated. Moreover, in a case where the cursor A is dragged in a state where the cursor A is on the string image E, the superimposed object C is then displayed again instead of the string image E.

An end point D of the string image E is displayed so as to be positioned in a range specified when the superimposed object C has been generated. This enables the user to visually recognize that an image (i.e., the superimposed object C) obtained by enlarging and displaying an image at a position of the end point D can be displayed by dragging the string image E in a display state illustrated in (b) of FIG. 3.

Further, another end of the string image E is displayed at a position (i.e., an end part of the display screen) to which the superimposed object C has been moved to be hidden (not displayed). That is, the string image E notifies the user that the superimposed object which was displayed at the position of the end point D has been moved to the end part of the display screen so as to be hidden. This allows the user to trace his/her memory as tracing from one end of the string to the other end, and therefore the user can easily recall which superimposed object was displayed.

As above described, according to the information processing device 1, the user can (i) take a superimposed object away from content as if by actually tying a string to the superimposed object and brushing aside the superimposed object when the superimposed object is unnecessary and (ii) cause the superimposed object to be displayed again, when necessary, as if by pulling the string so as to drag out the superimposed object. That is, the user can switch display/non-display of the superimposed object by an intuitive operation.

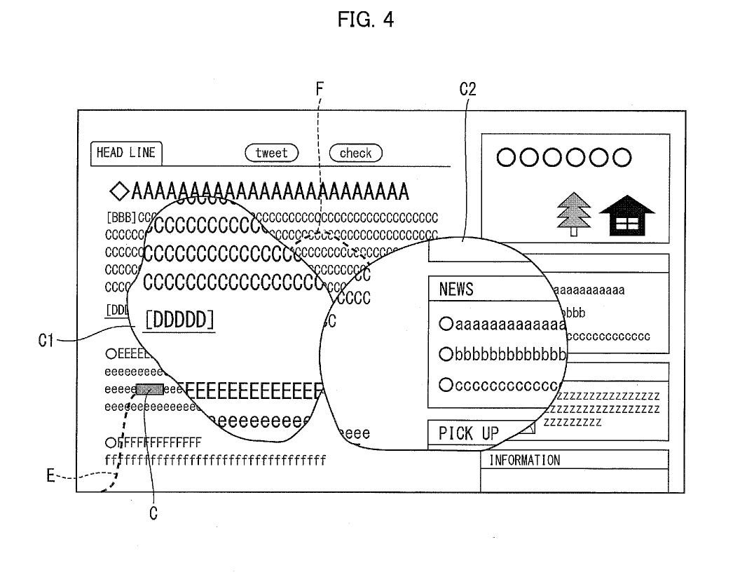

The following description discusses screen-display in a state where a superimposed object and another superimposed object are tied to each other, with reference to FIG. 4. In FIG. 4, a superimposed object C1 is tied to a superimposed object C2, and a string image F by which the superimposed object C1 and the superimposed object C2 are tied to each other is displayed. By thus tying the superimposed objects to each other, it is possible to collectively carry out a process with respect to the plurality of superimposed objects (details will be described later). Moreover, in the example illustrated in FIG. 4, a string image E (having an end point C in the specified range) is also displayed which indicates the presence of another superimposed object that is temporarily hidden.

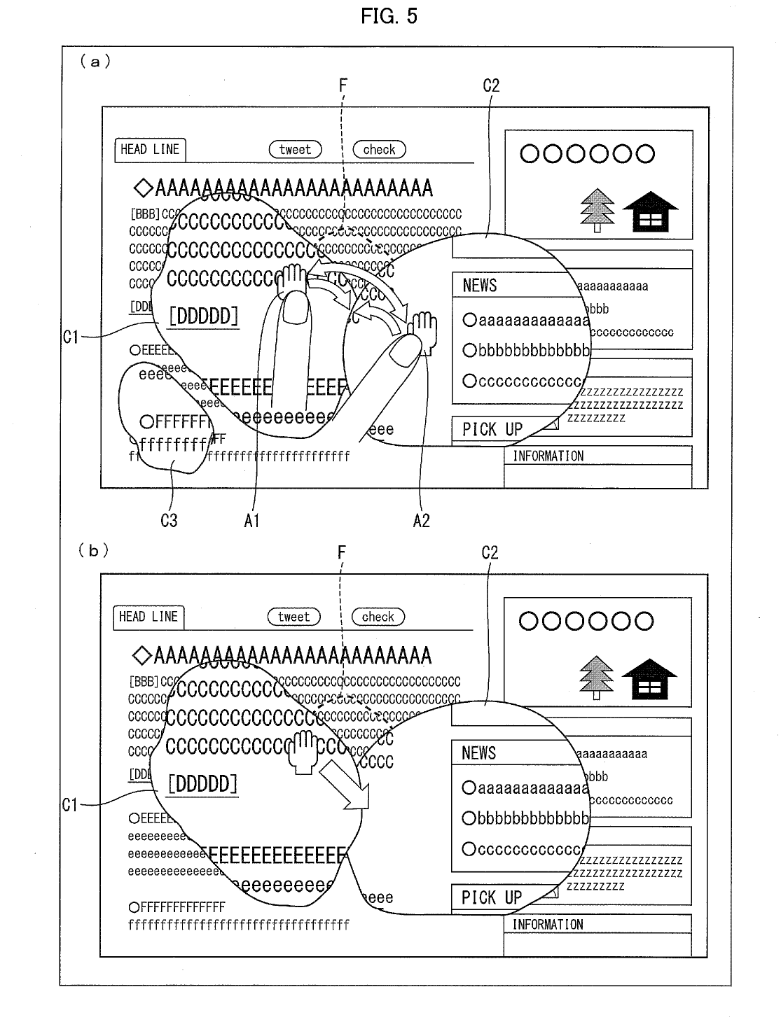

FIG. 5 illustrates an example of (i) an operation to tie superimposed objects to each other and (ii) an operation of untying. (a) of FIG. 5 illustrates an operation using two-point touch. (b) of FIG. 5 illustrates an operation to superimpose one superimposed object on another superimposed object. As illustrated in (a) of FIG. 5, in a case where a so-called pinch-in operation is carried out in a state where a cursor A1 is on a superimposed object C1 and a cursor A2 is on a superimposed object C2, a string image F for tying the superimposed objects C1 and C2 is displayed. Moreover, the superimposed objects C1 and C2 are associated with each other in the information processing device 1. In a case where a so-called pinch-out operation is carried out in a state where the superimposed objects C1 and C2 which are tied to each other are touched, the superimposed objects C1 and C2 are untied (i.e., tying is cancelled), and the display of the string image F is ended.

As illustrated in (b) of FIG. 5, in a case where an operation to drag the superimposed object C1 so as to be superimposed on the superimposed object C2 in a state where the cursor A1 is on the superimposed object C1, the superimposed objects C1 and C2 can be tied to each other. Note that an operation to tie superimposed objects to each other is not limited to a particular one, and it is preferable to carry out the tying by an intuitive operation as in the example illustrated in FIG. 5.

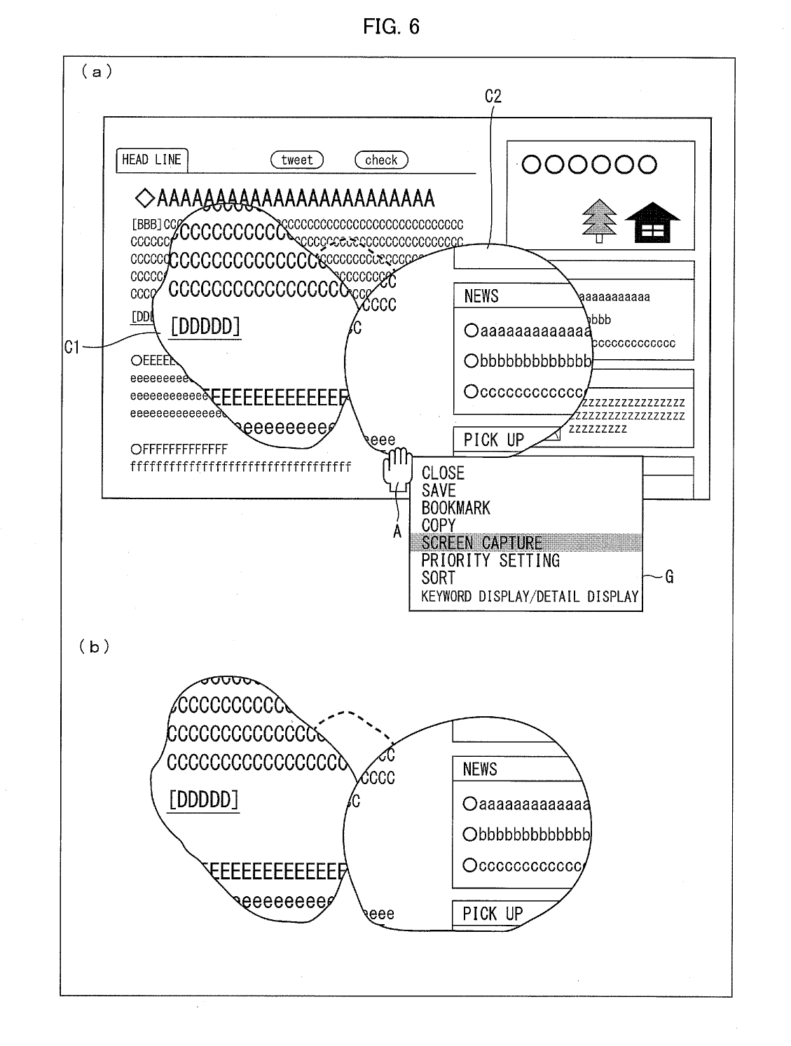

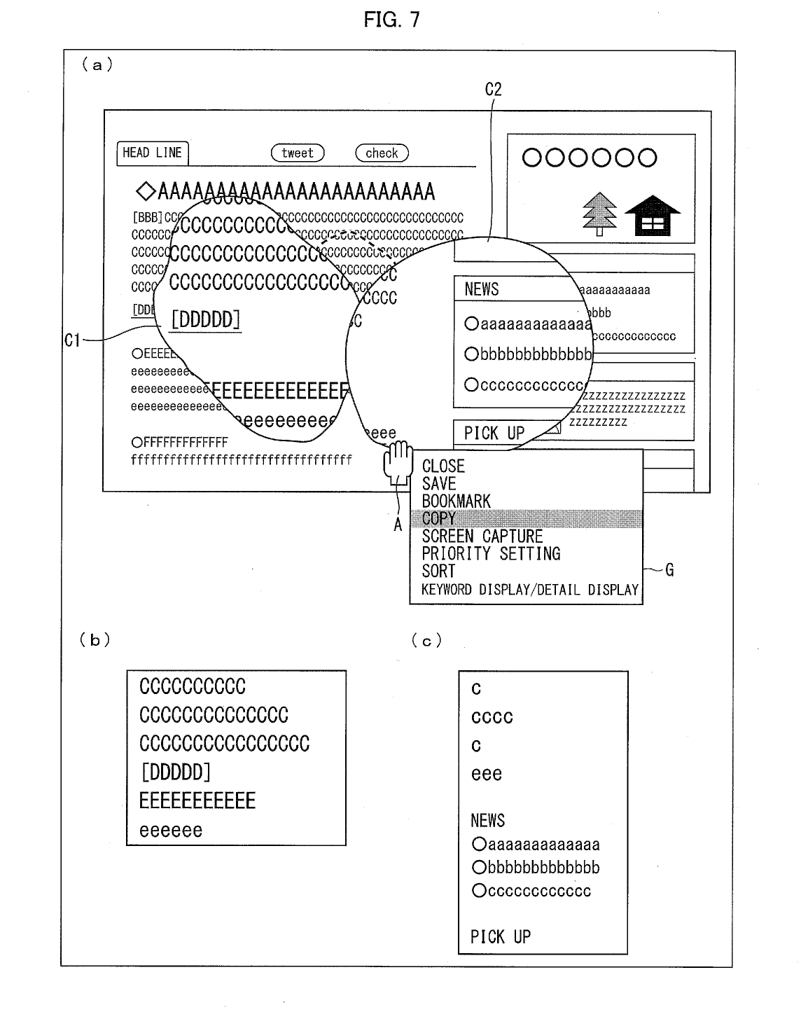

The following description discusses operations relating to screen-capturing and copying of a superimposed object, with reference to FIG. 6 and FIG. 7. (a) of FIG. 6 shows a state where an image capturing operation is carried out on the superimposed object C2.

As illustrated in (a) of FIG. 6, by displaying a menu G on the superimposed object C2 to be screen-captured and selecting an item “screen-capturing” in the menu G, an image of the superimposed object C2 is captured. Note that the menu G for carrying out operations with respect to a superimposed object can be displayed by, for example, a touch-and-hold operation of touching the superimposed object for a predetermined time period or more.

Here, the superimposed object C2 is tied to the superimposed object C1. Therefore, as illustrated in (b) of FIG. 6, an image of the superimposed object C1 and the string image are also captured along with the image of the superimposed object C2. Note that the capturing of the string image is not essential but it is preferable to capture the string image because the user can recognize, by an effect of the tying, that both the superimposed objects C1 and C2 have been captured.

By thus tying superimposed objects to each other, it is possible to collectively carry out a process with respect to a plurality of objects. For example, it is possible to collectively carry out also a process of copying a text string contained in each of superimposed objects. This is described below with reference to FIG. 7.

(a) of FIG. 7 shows a state where a copying operation is carried out with respect to the superimposed object C2. In this case, a text contained in the superimposed object C1 is copied as text data shown in (b) of FIG. 7, and a text contained in the superimposed object C2 is copied as text data shown in (c) of FIG. 7.

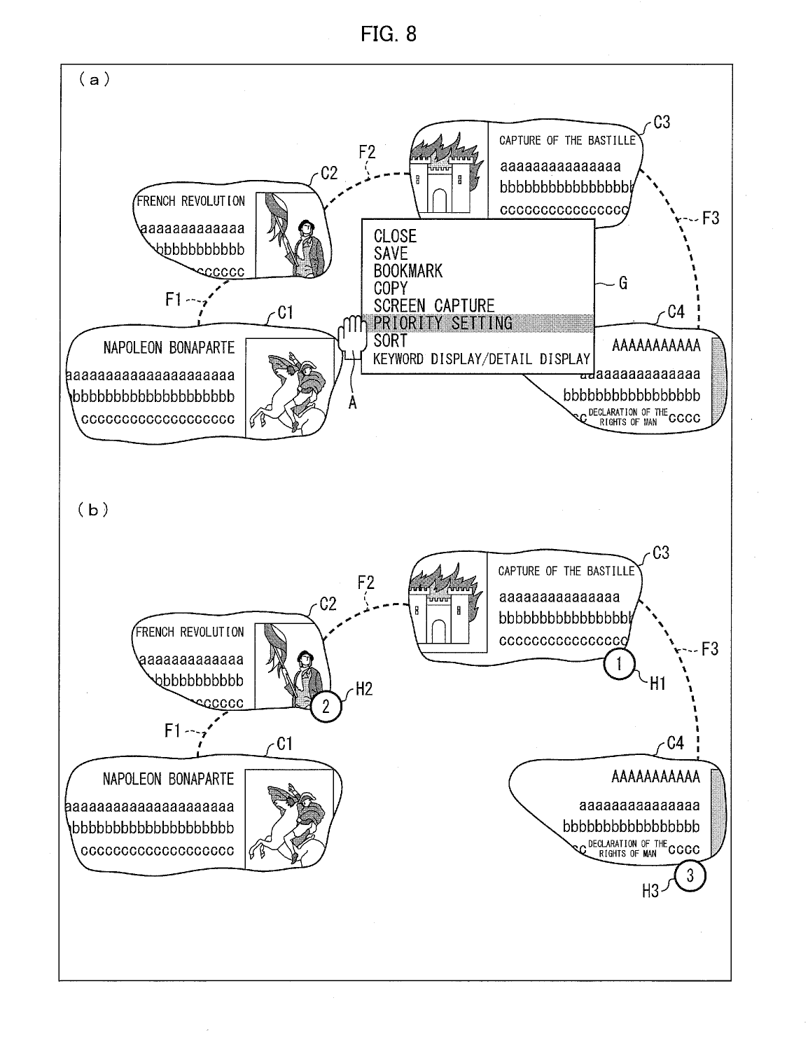

The following description discusses setting of a priority, with reference to FIG. 8. FIG. 8 is a view relating to priority setting on a tied superimposed object. In an example shown in (a) of FIG. 8, one of superimposed objects C1 through C4, which are tied to each other, is selected and an item “priority setting” in the menu G is selected. With this, priority values are set on the respective superimposed objects C1 through C4.

More specifically, in (a) of FIG. 8, the superimposed object C3 is selected and the menu G is displayed. In a case where the item “priority setting” in the menu G has been selected by the cursor A in this state, a setting window (not illustrated) for setting a priority value for the superimposed object C3 is displayed. Then, by selecting or inputting an intended priority value on the setting window, the priority value for the superimposed object C3 can be set. By carrying out this operation with respect to each of the superimposed objects, priority values for the respective superimposed objects C2 through C4 which are tied to each other are set, and the priority values thus set are indicated by “H1” through “H3”, respectively (see (b) of FIG. 8).

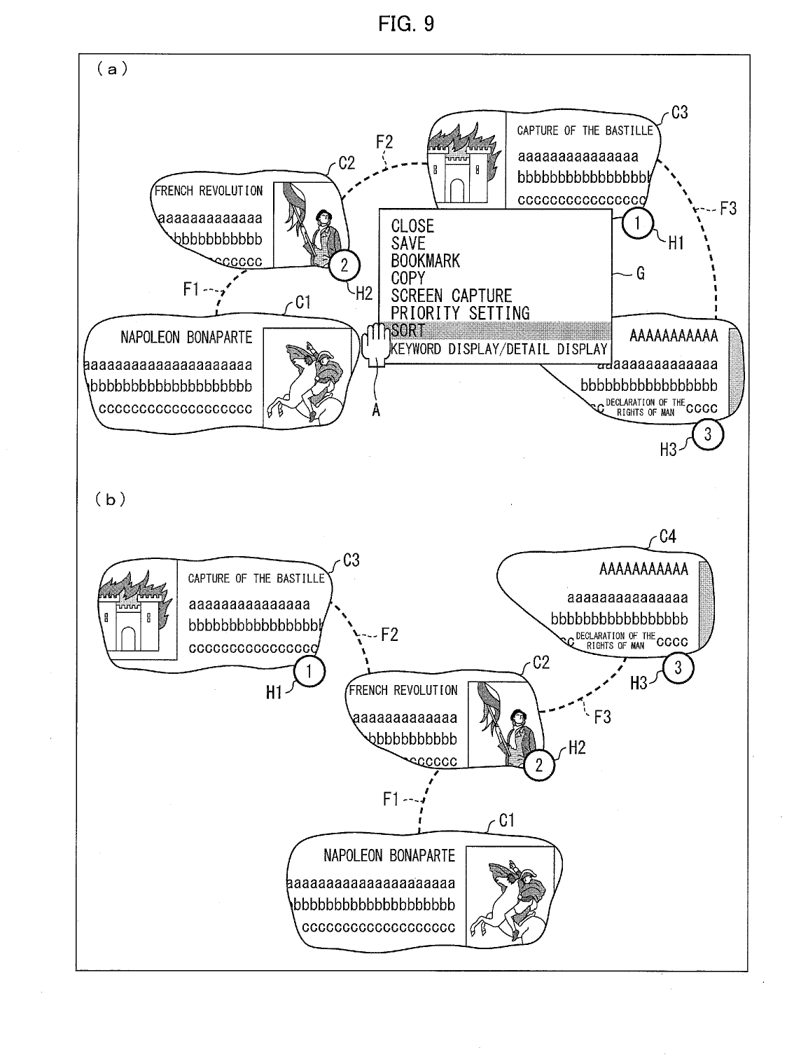

The following description discusses, with reference to FIG. 9, sorting of tied superimposed objects based on priority values. FIG. 9 shows an example of sorting tied superimposed objects.

In (a) of FIG. 9, the superimposed object C3 is selected and the menu G is displayed. In a case where an item “sorting” in the menu G is selected by the cursor A in this state, the superimposed objects C1 through C4 which are tied to each other are sorted based on priority values “H1” through “H3” so as to be in a state shown in (b) of FIG. 9. In (b) of FIG. 9, the superimposed objects C2 through C4 are arranged in an ascending order of priority values from the left. The superimposed object C1 for which no priority value is set is not sorted but a display position of the superimposed object C1 is changed in accordance with the movement of the superimposed object C2 to which the superimposed object C1 is tied. Note that, the superimposed objects C3 and C4 are tied to each other by a string image F3 in (a) of FIG. 9, and the superimposed objects C2 and C4 are tied to each other by the string image F3 in (b) of FIG. 9. As such, as long as the string image is displayed so that the user can recognize tied superimposed objects, a display position of the string image can be changed in a group of the tied superimposed objects, in accordance with the sorting.

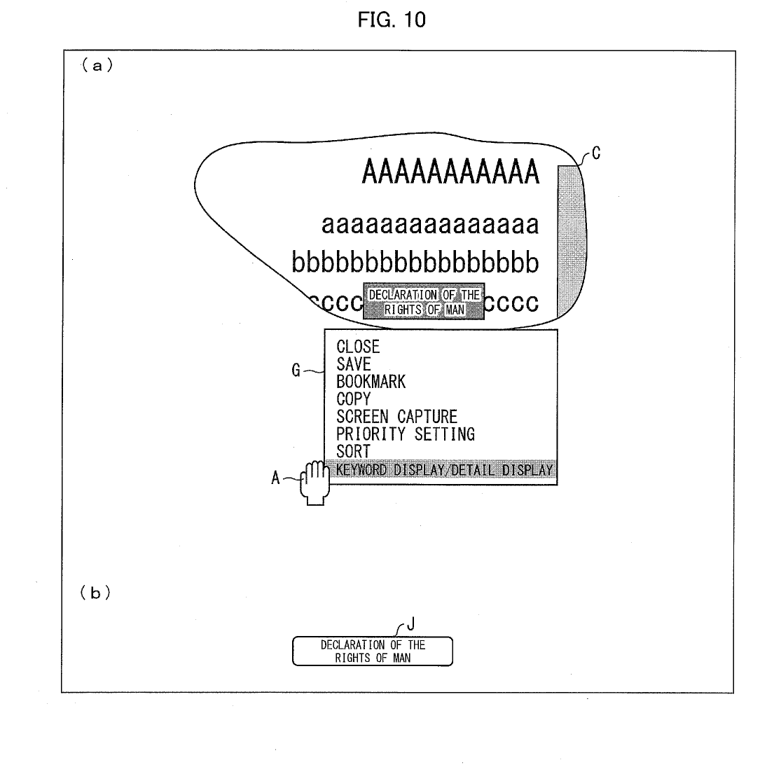

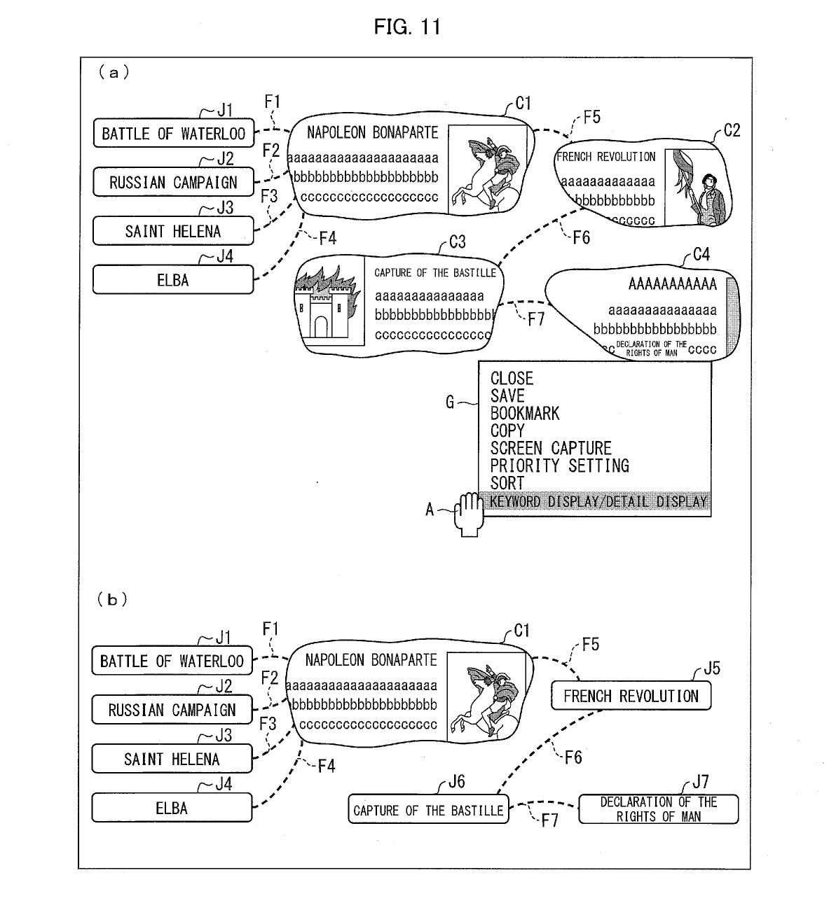

The following description discusses keyword setting and keyword display of a superimposed object, with reference to FIG. 10 and FIG. 11. (a) of FIG. 10 shows an operation to set a keyword with respect to a superimposed object and to display the keyword thus set. (b) of FIG. 10 shows a superimposed object in a keyword display state.

In (a) of FIG. 10, the menu G is displayed in a state where a text string “Declaration of the Rights of Man” displayed in the superimposed object C is selected and is in reverse display. In a case where an item “keyword display/detail display” in the menu G is selected by the cursor A in this state, the superimposed object C becomes a keyword display state in which the selected text string is determined to be a keyword. Specifically, as illustrated in (b) of FIG. 10, a superimposed object (hereinafter, referred to as “keyword object”) J containing selected characters “Declaration of the Rights of Man” is displayed instead of the superimposed object C.

The keyword object J is smaller in display size than the superimposed object C, and therefore an available space on the display screen is broadened. Moreover, since the text string displayed in the keyword object J is the text string which has been contained in the superimposed object C, the user can easily recognize that the keyword object J corresponds to the superimposed object C.

In an example of (a) of FIG. 11, the superimposed object C1 is tied to keyword objects J1 through J4 by respective string images F1 through F4. Moreover, superimposed objects C1 and C2 are tied to each other by a string image F5, superimposed objects C2 and C3 are tied to each other by a string image F6, and superimposed objects C3 and C4 are tied to each other by a string image F7. That is, in (a) of FIG. 11, the superimposed objects C1 through C4 are tied to the keyword objects J1 through J4.

In this state, as illustrated in (a) of FIG. 11, the menu G is displayed on the superimposed object C4 and the item “keyword display/detail display” for switching the keyword display and the detail display is selected. With this, the superimposed object C4 is replaced with a keyword object J7 as illustrated in (b) of FIG. 11. In this case, as illustrated in (b) of FIG. 11, the superimposed objects C2 and C3 tied to the superimposed object C4 can be replaced with keyword objects J5 and J6, respectively. Moreover, as with the superimposed object C1, it is possible that even a tied superimposed object is not replaced with a keyword object. Alternatively, whether or not to replace can be determined based on a condition such as the followings: i.e., a superimposed object tied to a keyword object is not replaced with a keyword object; or one of a plurality of tied superimposed objects is maintained as a superimposed object.

In this state, by displaying the menu G on the keyword object thus displayed as with (a) of FIG. 11 and selecting the item “keyword display/detail display”, it is possible to return to the display state illustrated in (a) of FIG. 11.

[Configuration of Device]

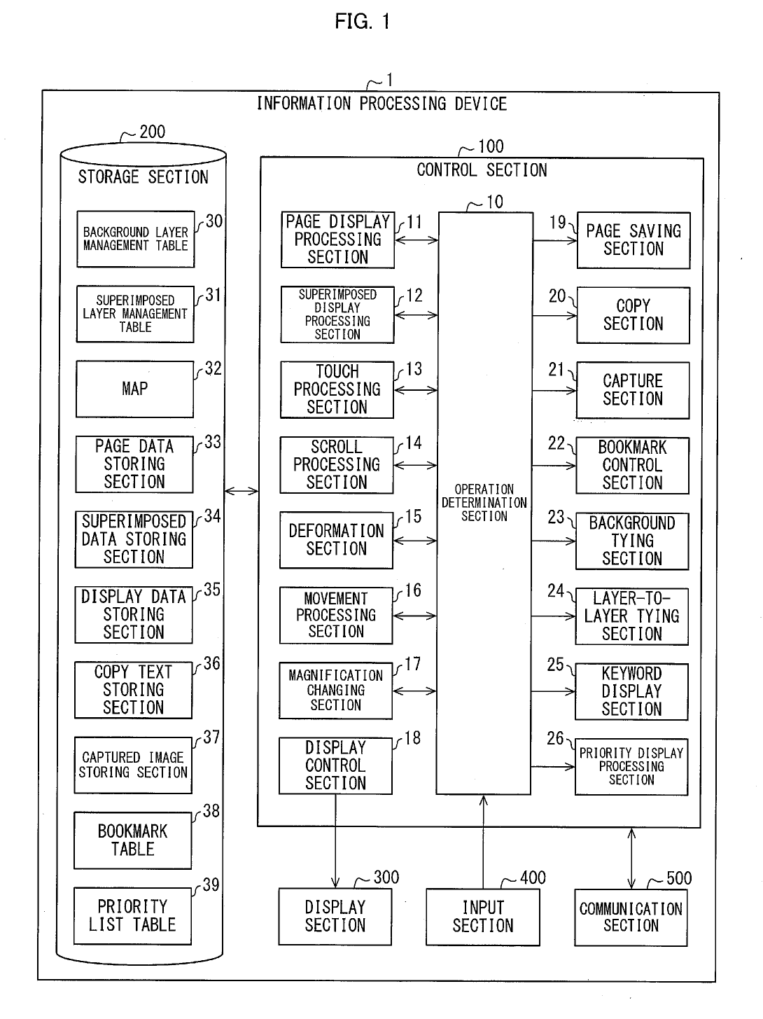

The following description discusses a configuration of the information processing device 1 with reference to FIG. 1. FIG. 1 is a block diagram showing an example of a configuration of a substantial part of the information processing device 1. As illustrated in FIG. 1, the information processing device 1 includes a control section 100, a storage section 200, a display section 300, an input section 400, and a communication section 500.

The control section 100 comprehensively controls functions of the information processing device 1. The control section 100 includes an operation determination section 10, a page display processing section 11, a superimposed display processing section (a superimposed display section) 12, a touch processing section 13, a scroll processing section 14, a deformation section 15, a movement processing section 16, a magnification changing section 17, a display control section 18, a page saving section 19, a copy section 20, a capture section 21, a bookmark control section 22, a background tying section (information displaying section) 23, a layer-to-layer tying section 24, a keyword display section (keyword displaying section, keyword setting section) 25, and a priority display processing section (sorting section) 26.

The operation determination section 10 receives an input signal in accordance with an input operation received by the input section 400. Then, the operation determination section 10 specifies, in accordance with the input signal and an image being displayed in the display section 300, an operation which has been carried out by a user. The operation determination section 10 causes each of sections of the control section 100 to carry out a process in accordance with the specified operation.

The page display processing section 11 carries out a process for displaying the web page. The superimposed display processing section 12 carries out a process for displaying the superimposed object (see FIG. 2). These processes will be specifically described later.

The touch processing section 13 carries out a process in response to a touch operation. Specifically, in a case where a link to a website is displayed at a position at which a tap operation has been carried out, the touch processing section 13 renews an image at that position with an image at a link destination. In a case where a button is displayed at the position at which the tap operation has been carried out, the touch processing section 13 carries out a process associated with the button in advance (e.g., start a predetermined program).

The scroll processing section 14 carries out a process in response to a scrolling operation. Specifically, in a case where the scrolling operation (e.g., a predetermined operation such as a drag operation or a flick operation) is carried out, the scroll processing section 14 scroll-displays an image being displayed at a position at which the scrolling operation has been carried out. That is, in a case where the scrolling operation is carried out on the superimposed object, the scroll processing section 14 scroll-displays an image of the superimposed object. In a case where the scrolling operation is carried out on a web page displayed in a background, the scroll processing section 14 scroll-displays an image of the web page.

The deformation section 15 deforms the superimposed object in accordance with an input operation that is carried out to deform the superimposed object. Note that the deformation of the superimposed object changes a range of an image displayed in the superimposed object. This makes it possible to say that the deformation section 15 changes a range of the superimposed object.

The movement processing section 16 moves the superimposed object to a position in accordance with an input operation that has been carried out to move the superimposed object. The movement processing section 16 changes a direction of the superimposed object on a display surface by rotating the superimposed object in a direction and at a rotation angle in accordance with an input operation that has been carried out to rotate the superimposed object.

The magnification changing section 17 changes, in accordance with an input operation that has been carried out to change a display magnification, a display magnification of an image displayed at a position at which the input operation has been carried out. Specifically, the magnification changing section 17 changes a display magnification of an image of the superimposed object in response to the input operation that has been carried out to change the display magnification on the superimposed object. Meanwhile, the magnification changing section 17 changes a display magnification of the web page in response to the input operation that has been carried out to change the display magnification on the web page displayed in the background.

The display control section 18 controls the display section 300 so as to display an image. Specifically, the display control section 18 transmits data to the display section 300 so that the display section 300 displays the data, the data being stored in the display data storing section 35 (described later).

The page saving section 19 carries out a process for saving the web page in the form of a file. The copy section 20 carries out a process for storing the text of the superimposed object (see (b) and (c) of FIG. 7). The capture section 21 carries out a process for storing the superimposed object in the form of an image (see (b) of FIG. 6). The bookmark control section 22 carries out a process related to bookmarking of the web page. These processes can be carried out by, for example, the operation with respect to the menu G illustrated in each of FIGS. 6 through 11.

The background tying section 23 causes notification information to be displayed so that the notification information is superimposed on the content in a state where a superimposed object is temporarily hidden. The notification information indicates a position at which an image from which the superimposed object has been obtained is displayed on the web page. Specifically, the background tying section 23 associates the superimposed object with the web page displayed as a background (i.e., with the web page from which the superimposed object has been obtained). In a case where the superimposed object has been dragged to an edge of the screen, the background tying section 23 causes a string image (notification information) to be displayed instead of the superimposed object so that a position on the web page from which the superimposed object has been obtained (i.e., a position of a range specified in order to display the superimposed object) is tied, by the string image, to a position at which the superimposed object was last displayed (i.e., a position to which the superimposed object has been moved so as to be temporarily hidden) (see (b) of FIG. 3).

In a case where a plurality of superimposed objects are displayed, the layer-to-layer tying section 24 associates the plurality of superimposed objects with each other and causes string images, by which the associated plurality of superimposed objects are tied to each other, to be displayed as information indicating that the plurality of superimposed objects are associated with each other (see FIG. 4). These processes are referred to as tying of superimposed objects (superimposed layers). In a case where a certain process is carried out with respect to one of tied superimposed objects, the certain process is carried out also with respect to the other superimposed objects which are tied to the one of the superimposed objects. That is, a process can be collectively carried out with respect to tied superimposed objects. Moreover, the tied superimposed objects can also be subjected to a sorting process described later.

Here, a batch process carried out with respect to tied superimposed objects is described. As shown in (a) of FIG. 6, in a case where an operation for a screen-capturing process has been carried out with respect to one of tied superimposed objects, the capture section 21 confirms whether or not another superimposed object tied to the one of tied superimposed objects exists. In a case where such another superimposed object exists, the another superimposed object is also captured. Moreover, in this case, a string image displayed between these superimposed objects can also be captured.

Similarly, as shown in (a) of FIG. 7, in a case where an operation for a copying process has been carried out with respect to one of tied superimposed objects, the copy section 20 confirms whether or not another superimposed object tied to the one of tied superimposed objects exists. In a case where such another superimposed object exists, the another superimposed object is also copied, i.e., text strings contained in respective of these superimposed objects can be copied.

Note that the process which can be carried out as a batch process is not limited to the above example and, for example, each of the following processes can be carried out as a batch process.

(1) Bookmark registering process by the bookmark control section 22
(2) Process of saving a web page as a file by the page saving section 19
(3) Display scroll process by the scroll processing section 14
(4) Deformation process by the deformation section 15
(5) Process of moving a display position of a superimposed object by the movement processing section 16
(6) Magnification changing process by the magnification changing section 17
That is, each of the constituent elements can serve as a batch processing section.

The keyword display section 25 carries out a process of setting a keyword for a superimposed object (see (a) of FIG. 10). Moreover, the keyword display section 25 carries out a process of causing the superimposed object to be in a keyword display state (i.e., causes a keyword object to be displayed instead of the superimposed object) (see (b) of FIG. 10). Note that the keyword display section 25 of course can be configured to carry out the keyword setting and the display switching by respective separate blocks.

The priority display processing section 26 carries out a process of setting a priority value for a superimposed object (see (a) and (b) of FIG. 8) and a sorting process for sorting a plurality of superimposed objects based on priority values (see (a) and (b) of FIG. 9). Each of these processes can be carried out by, for example, an operation to the menu G illustrated in FIGS. 6 through 11. Note that the priority display processing section 26 of course can be configured to carry out the priority value setting and the sorting by respective separate blocks.

The storage section 200 is a storage device for storing various types of data to be used by the information processing device 1. The storage section 200 includes a background layer management table 30, a superimposed layer management table 31, a map 32, a page data storing section 33, a superimposed data storing section 34, a display data storing section 35, a copy text storing section 36, a captured image storing section 37, a bookmark table 38, and a priority list table 39.

The background layer management table 30 is information that the page display processing section 11 uses to display the web page. The superimposed layer management table 31 is information that the superimposed display processing section 12 uses to display the superimposed object. Note that the page display processing section 11 causes the web page to be displayed on a layer different from a layer on which the superimposed display processing section 12 causes the superimposed object to be displayed. The following description refers to (i) a layer to be processed by the page display processing section 11 as a background layer and (ii) a layer to be processed by the superimposed display processing section 12 as a superimposed layer. The superimposed object is displayed based on the superimposed layer, and accordingly tying of the superimposed object can be expressed as tying of the superimposed layer.

The map 32 is information indicative of which one of data of the background layer and data of the superimposed layer to display in the display section 300. The map 32 will be specifically described later.

The page data storing section 33 stores therein image data to be displayed in the background layer. The superimposed data storing section 34 stores therein image data to be displayed in the superimposed layer. The display data storing section 35 stores therein image data to be displayed in the display section 300. In a case where the data stored in the page data storing section 33 and the data stored in the superimposed data storing section 34 are stored in the display data storing section 35 in accordance with the map 32, the superimposed object is displayed so as to be superimposed on the web page. These storing sections each can be constituted by, for example, a VRAM (Video RAM).

The copy text storing section 36 stores therein text data to be copied by the copy section 20. The captured image storing section 37 stores therein image data to be captured by the capture section 21. The bookmark table 38 is information that the bookmark control section 22 uses to manage a bookmark.

The priority list table 39 is information specifying a display order in the process of sorting superimposed objects. Details of the priority list table 39 will be described later.

The display section 300 is a display device for displaying an image in accordance with control of the control section 100. The input section 400 is an input device for receiving an input operation carried out by a user of the information processing device 1 and supplying the input operation to the control section 100. The following description discusses an example in which the display section 300 and the input section 400 are configured such that a display surface of the display section 300 serves as an input surface of the input section 400. That is, the following description discusses an example in which the information processing device 1 includes a touch panel. It is needless to say that a configuration of the display section 300 and the input section 400 is not limited to this example, provided that the display section 300 has a function of displaying the image and the input section 400 has a function of receiving the input operation. Further, the display section 300 and the input section 400 each can be an external device externally attached to the information processing device 1.

The communication section 500 is a communication device that the information processing device 1 uses to communicate with an external device. Specifically, the information processing device 1 causes the communication section 500 to receive content such as a web page via a network such as the Internet.

### Specific Example of Table

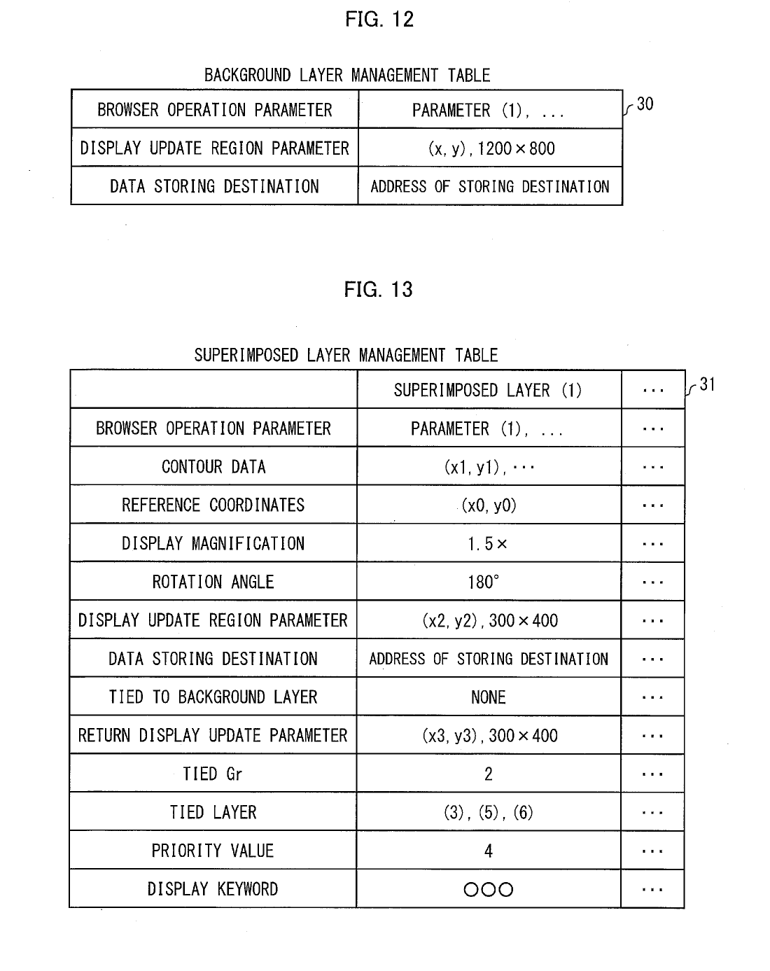

FIG. 12 shows a specific example of the background layer management table 30. The background layer management table 30 shown in FIG. 12 is a table in which a browser operation parameter, a display update region parameter, and a data storing destination are associated with each other.

The browser operation parameter is a parameter necessary for a display of a web page in the background layer and operation of the web page. The display update region parameter, which is a parameter indicative of a region to be updated on the display screen, is used to update a display in the background layer. According to the example shown in FIG. 12, a rectangular region to be updated is represented by (i) coordinates (x,y) of an upper left corner of the rectangular region and (ii) a width (1200 pixels) and a height (800 pixels). The data storing destination refers to an address of a destination in the page data storing section 33 at which destination a web page to be displayed in the background layer is stored.

FIG. 13 shows a specific example of the superimposed layer management table 31. The superimposed layer management table 31 shown in FIG. 13 is a table in which a browser operation parameter, contour data, reference coordinates, a display magnification, a rotation angle, a display update region parameter, a data storing destination, tied to background layer, a return display update parameter, a tied Gr (group), a tied layer, a priority value, and a display keyword are associated with each other.

The browser operation parameter is a parameter necessary for a display of a web page in the superimposed layer and operation of the web page. The contour data is data indicative of a contour of the superimposed object. According to the example shown in FIG. 13, the superimposed layer management table 31 stores therein, in the form of contour data, all sets of coordinates constituting a trajectory of an operation to specify the range of the superimposed object. The reference coordinates are coordinates to be used as a reference for converting coordinates of a touch position on the display screen into coordinates of a touch position in the superimposed layer. The reference coordinates will be specifically described later. The display magnification is a parameter indicative of a magnification at which to display an image in the superimposed object with respect to an image of the original web page. The rotation angle is a parameter indicative of a rotation angle at which to rotate, with respect to the image of the original web page, the image to be displayed in the superimposed object. The display update region parameter, which is a parameter indicative of a region to be updated on the display screen, is used to update a display in the superimposed layer. According to the example shown in FIG. 13, a rectangular region to be updated is represented by (i) coordinates (x2,y2) of an upper left corner of the rectangular region and (ii) a width (300 pixels) and a height (400 pixels). The data storing destination refers to an address of a destination in the superimposed data storing section 34 at which destination content to be displayed in the superimposed layer is stored.

The parameter “tied to background layer” indicates whether or not a superimposed layer is tied to a background layer. In the example illustrated in FIG. 13, the parameter is NO which indicates that the superimposed layer is not tied to the background layer. Here, in a case where the superimposed object has been dragged to the outside of the screen, the parameter is updated to “YES” and a string image is displayed instead of the superimposed object. As such, based on a value of the parameter, it is possible to determine which one of the superimposed object and the string image is an image to be displayed in the superimposed layer.

The return display update parameter is used when the superimposed object is displayed again instead of the string image. In the example illustrated in FIG. 13, a rectangular region to be updated for displaying the superimposed object again is indicated by coordinates (x3, y3) of its upper left corner, a width (300 pixels), and a height (400 pixels).

The tied group is a parameter for identifying a plurality of tied superimposed objects as one group, and one tied group parameter is set for superimposed objects, which are tied to each other, so that the superimposed objects are regarded as belonging to the same group. In the example illustrated in FIG. 13, the tied group is “2”, which indicates that the superimposed layer is tied to another superimposed layer whose tied group is “2”. The parameter of tied layer indicates another tied superimposed layer (superimposed object).

The priority value indicates a display priority of a superimposed object and is used when superimposed objects are sorted. The display keyword indicates a keyword to be displayed in the keyword display state of the superimposed object.

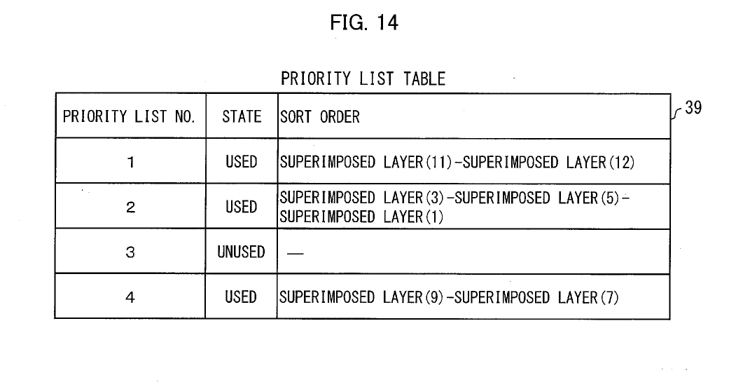

FIG. 14 shows a specific example of the priority list table 39. The priority list table 39 shown in FIG. 14 is a table in which a priority list NO. (number), a state, and a sort order are associated with each other. Note that a combination of the priority list number, the state, and the sort order is referred to as “priority list”.

The priority list number is a value associated with a tied group in the superimposed layer management table 31, and the priority list number can be specified based on the tied group. Here, the value of the tied group is identical with the value of the priority list number in the priority list used to sort superimposed objects in the tied group.

That is, in a case where superimposed objects in a certain tied group are sorted, the superimposed objects are sorted in a sort order of a priority list specified by a priority list number whose value is identical with that of the certain tied group. For example, in a case where sorting of the superimposed layer (1) in FIG. 13 is carried out, the tied group is “2” and therefore superimposed layers are sorted in an order of (3)-(5)-(1) in accordance with a sort order of a priority list number “2” in FIG. 14.

[Map]

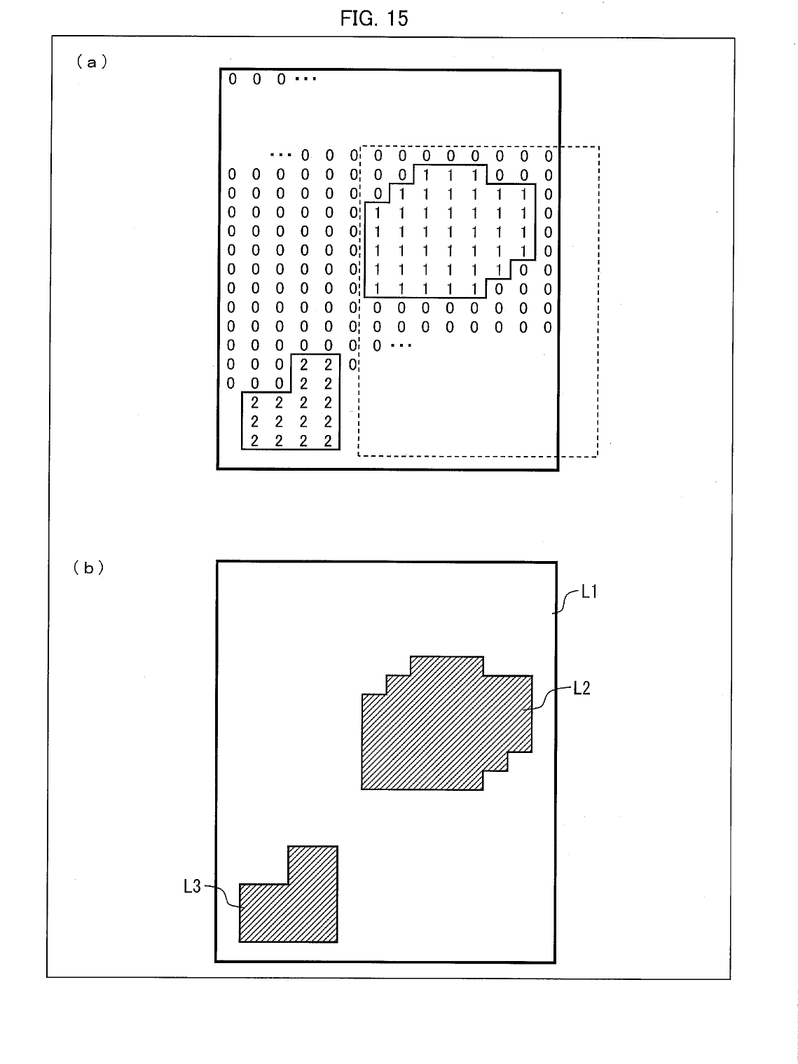

The following description discusses the map 32 with reference to FIG. 15. FIG. 15 illustrates the map 32. (a) of FIG. 15 shows an example of setting of the map 32. (b) of FIG. 15 shows an example of a layer display in accordance with the map 32 illustrated in (a) of FIG. 15. In (a) of FIG. 15, a range of pixels whose data is stored in the superimposed data storing section 34 is shown by a broken line.

According the map 32, “transmissive”, which is an attribute for displaying data of the background layer, or “superimposed”, which is an attribute for displaying data of the superimposed layer, is set for each of pixels constituting an image to be displayed. More specifically, a pixel having the transmissive attribute is set to have a value of “0”, and a pixel having the superimposed attribute is set to have a value of n (n is an integer not less than 1). According to the example shown in (a) of FIG. 15, a value of “0”, “1”, or “2” is set for each of the pixels. The information processing device 1 displays data of an identical layer in pixels for which an identical value is set.

That is, as illustrated in (b) of FIG. 15, in a case where the map 32 illustrated in (a) of FIG. 15 is used, an image L1 of the background layer is displayed in pixels for which the value of “0” is set. An image L2 of the superimposed layer is displayed in a case where a display is carried out in accordance with data of pixels which data is stored in the superimposed data storing section 34 and for which the value of “1” is set. Similarly, an image L3 of another superimposed layer is displayed in pixels for which the value of “2” is set.

Since the map 32 thus shows a region in which the data of the pixels of the superimposed layer needs to be displayed, only a part of a web page in the superimposed layer can be displayed with reference to the map 32 so as to be superimposed on a web page in the background layer. That is, according to the information processing device 1, in a case where an operation to specify a range of a web page is carried out, that web page is opened in a new layer (a superimposed layer). Then, the superimposed object is displayed by screen-displaying, in accordance with the map 32, only a part of the newly opened web page which part corresponds to the specified range.

Moreover, as attributes other than those above, an attribute “string image” for displaying a string image and an attribute “layer to be superimposed” indicating a superimposing relation of superimposed layers are set in the map 32. Setting of these attributes will be described later.

[How to Specify Touch Position in Superimposed Layer in Accordance with Reference Coordinates]

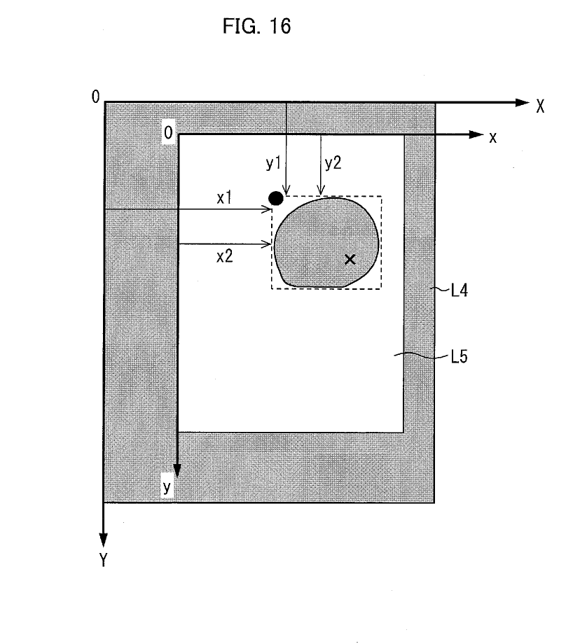

The following description discusses, with reference to FIG. 16, how to specify, in accordance with reference coordinates, a touch position in the superimposed layer. FIG. 16 illustrates how to specify, in accordance with the reference coordinates, the touch position in the superimposed layer. In FIG. 16, the superimposed layer is indicated by L4 and the background layer is indicated by L5.

The superimposed layer L4, in which a web page of the background layer L5 is enlarged and displayed, is larger than the background layer L5. However, an image of the superimposed layer L4 which image is to be displayed is only an image of a part of the superimposed layer L4 which part is located in the background layer L5 and corresponds to the pixels having the superimposed attribute in the map 32. That is, only the part of the image of the superimposed layer L4 which part corresponds to the pixels having the superimposed attribute is displayed as the superimposed object.

In FIG. 16, a rectangular region including the superimposed object is shown by a broken line. Coordinates of an upper left corner of the rectangular region serve as the reference coordinates. That is, the reference coordinates can be found by specifying the rectangular region in accordance with contour data on the superimposed object. The reference coordinates are expressed as (x1,y1) in the superimposed layer L4 assuming that an origin at an upper left corner of the superimposed layer L4 is a reference. The reference coordinates are expressed as (x2,y2) in the background layer L5 assuming that an origin at an upper left corner of the background layer L5 is a reference.

Assume here that a touch operation has been carried out with respect to a point x on the superimposed object. In a case where the touch operation has been carried out at a position whose coordinates (assuming that the origin at the upper left corner of the background layer L5 is the reference) are expressed as (x,y), coordinates of the touch position in the superimposed layer are expressed as (x1-x2+x,y1-y2+y). Use of this coordinate value makes it possible to specify what operation has been carried out with respect to the superimposed layer (e.g., which link has been selected).

[Object Display Process]

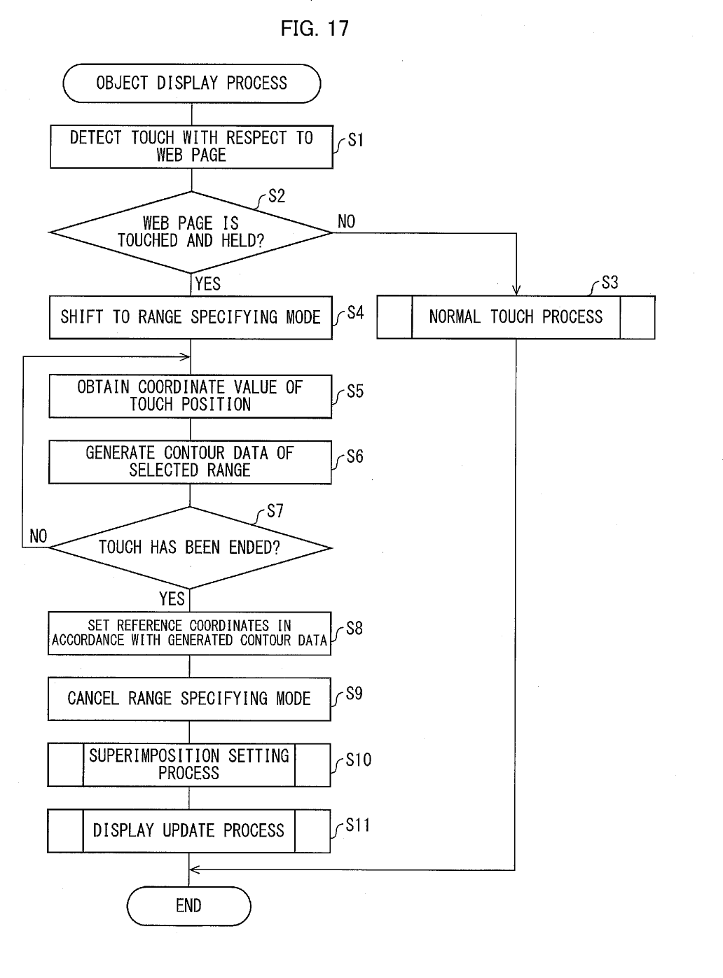

The following description discusses, with reference to FIG. 17, how to carry out an object display process (a display control method), which is a process for displaying the superimposed object. FIG. 17 is a flow chart showing an example of the object display process.

First, the operation determination section 10 detects, in accordance with information notified by the input section 400, that a touch operation has been carried out with respect to a web page which is being displayed (S1). Then, the operation determination section 10 determines whether or not the touch operation is a touch-and-hold operation (an identical position is being touched for not less than a predetermined time period) (S2).

The operation determination section 10 which has determined that the touch operation is not the touch-and-hold operation (NO at S2) determines that a normal touch operation has been carried out, and notifies the touch processing section 13 of coordinates of the touch position so as to cause the touch processing section 13 to carry out a normal touch process (S3). According to the normal touch process, the touch processing section 13 carries out a process in accordance with the touched position. For example, in a case where a link is displayed at the touch position, the touch processing section 13 carries out a process for displaying content at a link destination. In a case where a button is displayed at the touch position, the touch processing section 13 carries out a process in accordance with the button. In a case where the normal touch process is carried out, the information processing device 1 ends the object display process.

Meanwhile, the operation determination section 10 which has determined that the touch operation is the touch-and-hold operation (YES at S2) gives the superimposed display processing section 12 a notification of the determination. The superimposed display processing section 12 which has received the notification shifts to a range specifying mode (S4). The superimposed display processing section 12 which has shifted to the range specifying mode displays a cursor prestored for the range specifying mode, instead of a cursor which had been displayed before the superimposed display processing section 12 shifted to the range specifying mode. The superimposed display processing section 12 obtains, via the operation determination section 10, a coordinate value of the touch position which has been received by the input section 400 (S5, a receiving step). Subsequently, the superimposed display processing section 12 generates, from the obtained coordinate value, contour data indicative of a contour of a selected range (a trajectory of the touch position in the range specifying mode) (S6), and then determines whether or not the touch operation has been ended (S7).

In a case where the superimposed display processing section 12 has determined that the touch operation has not been ended (NO at S7), the process returns to S5. Meanwhile, the superimposed display processing section 12 which has determined that the touch operation has been ended (YES at S7) sets reference coordinates in accordance with the generated contour data (S8). Then, the superimposed display processing section 12 cancels the range specifying mode (S9) and carries out a superimposition setting process (S10, a superimposed display step). Thereafter, the display control section 18 carries out a display update process (S11), so that the superimposed object is displayed. With this, the object display process is ended.

Note that, before the process of S10 is carried out, content data (which constitutes a web page and is, for example, an HTML file and image data) whose range has been specified in the background layer is stored in the page data storing section 33, and an address at which the content data is stored is set in the superimposed layer management table 31.

[Superimposition Setting Process]

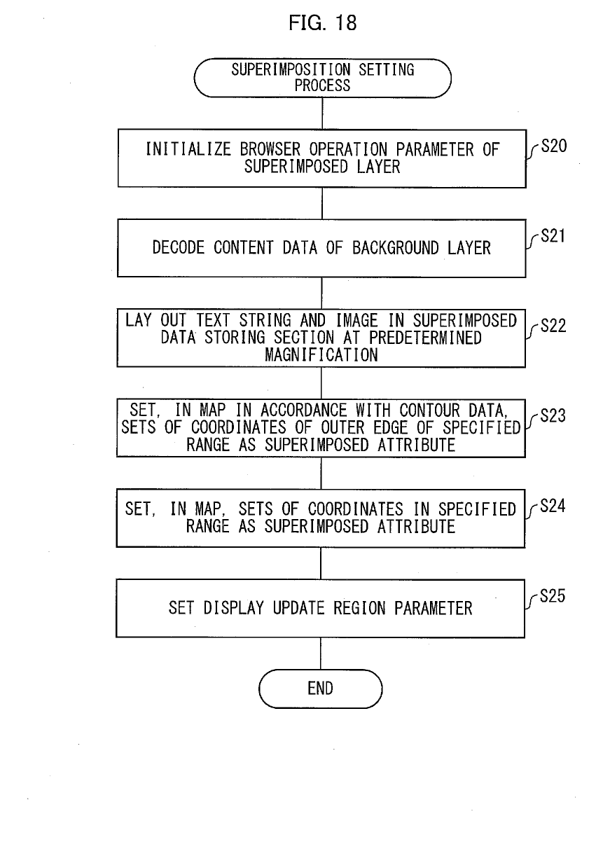

The following description specifically discusses, with reference to FIG. 18, the superimposition setting process carried out at S10 of FIG. 17. FIG. 18 is a flow chart showing an example of the superimposition setting process. The superimposition setting process is a process for displaying the superimposed object so that the superimposed object is superimposed on the web page.

First, the superimposed display processing section initializes a browser operation parameter of the superimposed layer in the superimposed layer management table 31 (S20). Further, the superimposed display processing section 12 decodes (or analyzes) content data indicated by an address of a destination included in the superimposed layer management table 31 (S21). Then, the superimposed display processing section 12 (i) enlarges, at a predetermined magnification, a text string and an image each obtained by the decoding and (ii) lays out the text string and the image in the superimposed data storing section 34 (S22). Note that the magnification can be 1×in a case where the text string and the image do not need to be enlarged.

Subsequently, the superimposed display processing section 12 sets, in the map 32 in accordance with the contour data generated at S6 of FIG. 17, sets of coordinates of an outer edge of a specified range (sets of coordinates which sets constitute a trajectory of an operation to specify a range) as the superimposed attribute (S23). The superimposed display processing section 12 sets, in the map 32, sets of coordinates in the specified range (a region surrounded by the trajectory of the operation to specify the range) as the superimposed attribute (S24). Then, the superimposed display processing section 12 sets a display update region parameter indicative of a region in which a display is to be updated (e.g., a parameter indicative of (i) reference coordinates and (ii) a width and a height of a rectangular region including the contour data) (S25), and stores the display update region parameter in the superimposed layer management table 31. Further, the superimposed display processing section 12 notifies the display control section 18 that the display update region parameter has been updated. With this, the superimposition setting process is ended.

[Display Update Process]

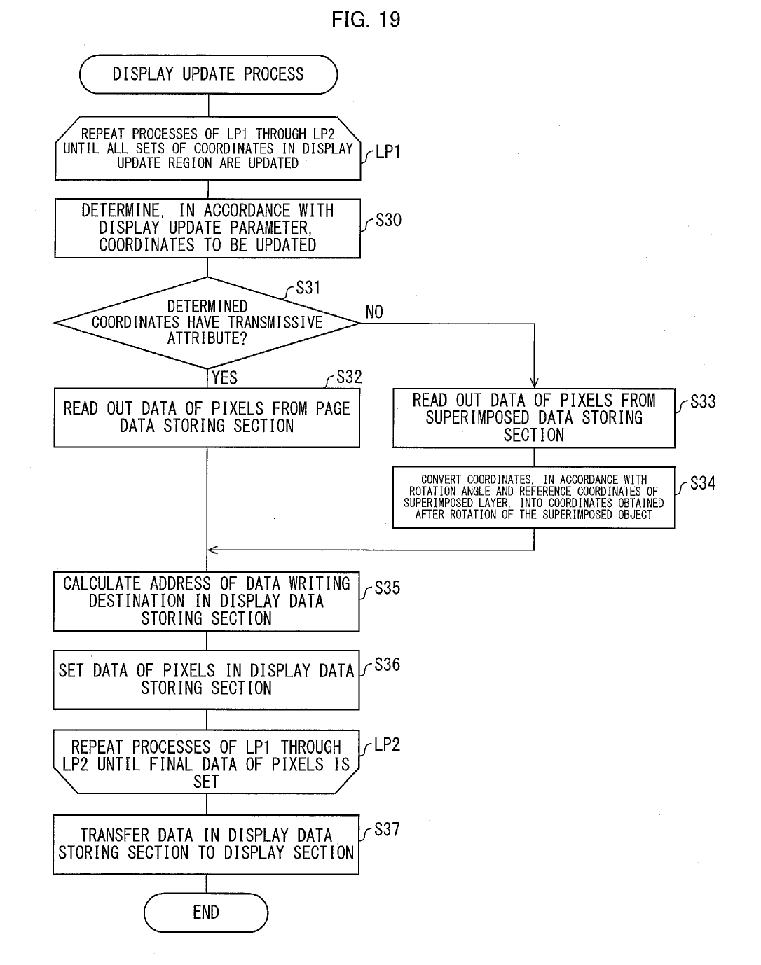

The following description specifically discusses, with reference to FIG. 19, the display update process carried out at S11 shown in FIG. 17. FIG. 19 is a flow chart showing an example of the display update process. The display control section 18 which has been notified that the display update region parameter has been updated carries out processes from LP1 to LP2 with respect to all sets of coordinates in a display update region. First, the display control section 18 determines, in accordance with the display update region parameter, coordinates to be updated (S30). Specifically, the display control section 18 determines a set of coordinates from the sets of coordinates in the region indicated by the display update region parameter. Subsequently, the display control section 18 determines, with reference to the map 32, whether or not the determined set of coordinates has the “transmissive” attribute (S31).

The display control section 18 which has determined that the determined set of coordinates has the “transmissive” attribute (YES at S31) reads out, from the page data storing section 33, data of pixels corresponding to the set of coordinates which set was determined at S30 (S32), and then the process proceeds to S35. Meanwhile, the display control section 18 which has determined that the determined set of coordinates has no “transmissive” attribute (has the “superimposed” attribute) (NO at S31) reads out, from the superimposed data storing section 34, the data of the pixels corresponding to the set of coordinates which set was determined at S30 (S33). Further, the display control section 18 converts that set of coordinates, in accordance with a rotation angle and reference coordinates of the superimposed layer, into coordinates obtained after rotation of the superimposed object (S34), and then the process proceeds to S35.

At S35, the display control section 18 calculates an address of a data writing destination in the display data storing section 35, the address corresponding to the set of coordinates (the set of coordinates which set was determined at S30 or the coordinates obtained after the conversion at S34). Then, the display control section 18 sets, in the display data storing section 35, the data of the pixels which data was read out at S32 or S33 (S36). The display control section 18 which has finished carrying out the processes of S30 through S36 (described above) with respect to all the sets of coordinates in the region indicated by the display update region parameter transfers the data in the display data storing section 35 to the display section 300 (S37). With this, an image displayed in the display section 300 is updated, and the display update process is ended.

[Touch Operation Handling Process]

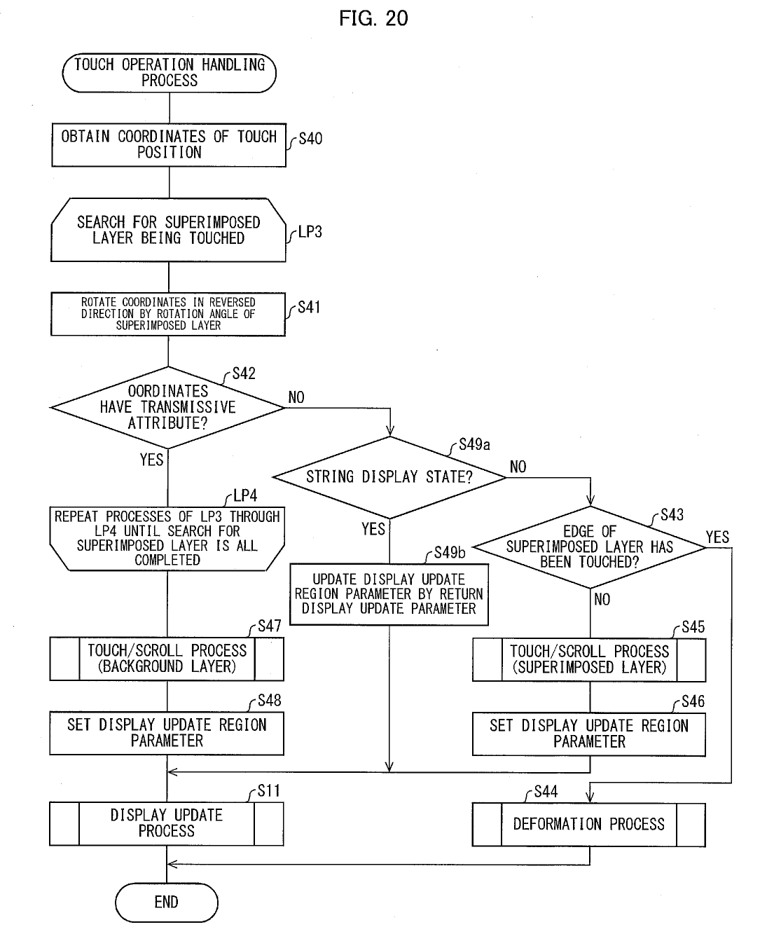

The following description discusses, with reference to FIG. 20, a touch operation handling process to be carried out when a touch operation has been carried out. FIG. 20 is a flow chart showing an example of the touch operation handling process. Note that the touch operation refers to an operation carried out by touching a display surface with one finger.

First, the operation determination section 10 which has detected, in accordance with the information notified by the input section 400, that a touch operation has been carried out with respect to a web page which is being displayed obtains coordinates of a touch position (S40). Thereafter, the operation determination section 10 (i) searches, with reference to the map 32, for a superimposed layer being touched, and (ii) repeats the processes from LP3 to LP4 until completion of the search for the superimposed layer.

In the processes from LP3 to LP4, the operation determination section 10 reads out first, from the superimposed layer management table 31, a rotation angle and reference coordinates of the detected superimposed layer, and then carries out coordinate conversion in which the coordinates obtained at S40 rotate about the reference coordinates in a reversed direction by the rotation angle (S41). Note that, in a case where the detected superimposed layer has not been rotated, the operation determination section 10 carries out the process of S41 assuming that the rotation angle is 0. In this case, where the coordinates are unchanged at S41, such an arrangement makes it possible to standardize procedures for the process irrespective of whether or not the superimposed layer has been rotated.

Subsequently, the operation determination section 10 determines, with reference to the map 32, whether or not the coordinates obtained by carrying out the conversion at S41 have the transmissive attribute (S42). The operation determination section 10 which has determined that the coordinates have no transmissive attribute (have the superimposed attribute) (NO at S42) notifies the background tying section 23 of this determination. The background tying section 23 which has received the notification determines whether or not the detected superimposed layer is in a string display state (S49a). Specifically, in a case where the background tying section has read out information relating to the detect superimposed layer from the superimposed layer management table 31 and the parameter “tied to background layer” is “YES”, the background tying section 23 determines that the superimposed layer is in the string display state.

Here, in a case where the background tying section 23 has determined that the detected superimposed layer is in the string display state (YES at S49a), the background tying section 23 notifies the superimposed display processing section 12 of this determination. Upon receipt of the notification, the superimposed display processing section 12 updates the display update region parameter by the return display update parameter in the superimposed layer management table 31 (S49b), and notifies the display control section 18 of the update of the display update region parameter. Upon receipt of the notification, the display control section 18 carries out a display update process (S11), and the touch operation handling process is ended. With this, the superimposed object corresponding to the detected superimposed layer is displayed again instead of the string image which has been displayed. Note that the operation to display the superimposed object again can be an operation to drag the string image or an operation other than this.

On the other hand, in a case where the background tying section 23 has determined that the detected superimposed layer is not in the string display state (NO at S49a), the background tying section 23 notifies the operation determination section 10 of this determination. Upon receipt of the notification, the operation determination section 10 determines whether or not an edge (outer edge) of the superimposed layer has been touched (S43). Specifically, in a case where the coordinates obtained at S40 are located in (i) a first pixel (an outermost pixel) defining a contour of the superimposed layer or (ii) a second pixel of the superimposed layer which second pixel is located within a predetermined range from the first pixel, the operation determination section 10 determines, with reference to the map 32, that the edge has been touched.

The operation determination section 10 which has determined that the edge has been touched (YES at S43) determines that an operation to carry out a deformation process has been carried out, and gives the deformation section 15 a notification of the determination. The deformation section 15 which has received the notification carries out the deformation process in accordance with the touch operation so as to deform the superimposed object (S44). With this, the touch operation handling process is ended.

Meanwhile, in a case where the operation determination section 10 has determined that no edge has been touched (a region inside of the outer edge of the superimposed object has been touched) (NO at S43), the touch process or the scroll process is carried out with respect to the superimposed layer (S45). Specifically, in a case where the touch position has been unchanged and the touch has been ended within a predetermined time period, the operation determination section 10 notifies the touch processing section 13 of (i) coordinates of the touch position and (ii) the superimposed layer which has been subjected to the touch operation, and causes the touch processing section 13 to carry out the touch process. According to the touch process, in a case where there is a link at the touch position, the touch processing section 13 downloads content at a link destination and decodes the downloaded content. Then, the touch processing section 13 lays out, in the superimposed data storing section 34, a text string and an image which are contained in data of the content at a predetermined magnification. In a case where the touch position has been changed within the predetermined time period, the operation determination section 10 notifies the scroll processing section 14 of (i) the touch position which has not been changed and the touch position which has been changed and (ii) the superimposed layer which has been subjected to the touch operation, and causes the scroll processing section 14 to carry out the scroll process. According to the scroll process, the scroll processing section 14 changes, in accordance with a change in coordinate value of the touch position, data to be stored in the superimposed data storing section 34. The touch processing section 13 or the scroll processing section 14 sets a display update region parameter indicative of a region including the superimposed layer which has been subjected to the touch operation (S46), and then notifies the display control section 18 that the display update region parameter has been updated. Thereafter, the display control section 18 carries out the display update process (described earlier) (S11). With this, the image displayed in the display section 300 is updated, and the touch operation handling process is ended.

In a case where the search for the superimposed layer has been all completed when the operation determination section 10 determines at S42 that the coordinates have the transmissive attribute (YES at S42), the touch process or the scroll process is carried out with respect to the background layer (S47). Note that, since the touch process and the scroll process which are carried out with respect to the background layer are different in layer to be processed but similar to those carried out at S45, a specific description thereof is omitted here. The touch processing section 13 or the scroll processing section 14 sets a display update region parameter indicative of a region of the background layer (S48), and then notifies the display control section 18 of the display update region parameter. Thereafter, the display control section 18 carries out the display update process (S11). With this, the image displayed in the display section 300 is updated, and the touch operation handling process is ended.

[Two-Finger Touch Operation Handling Process]

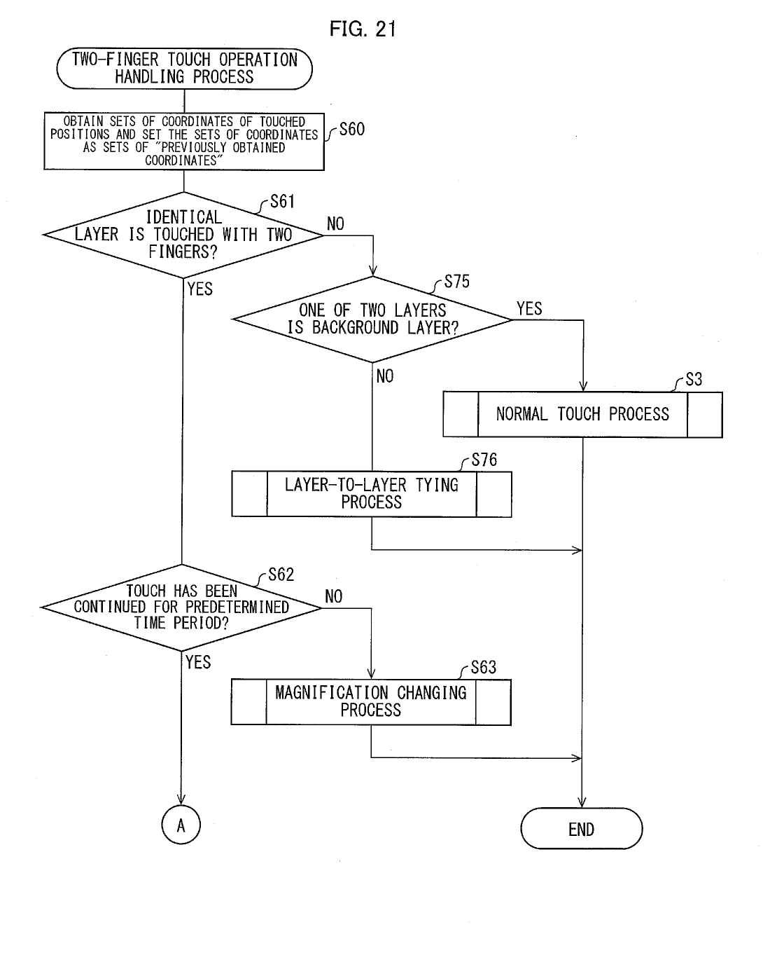

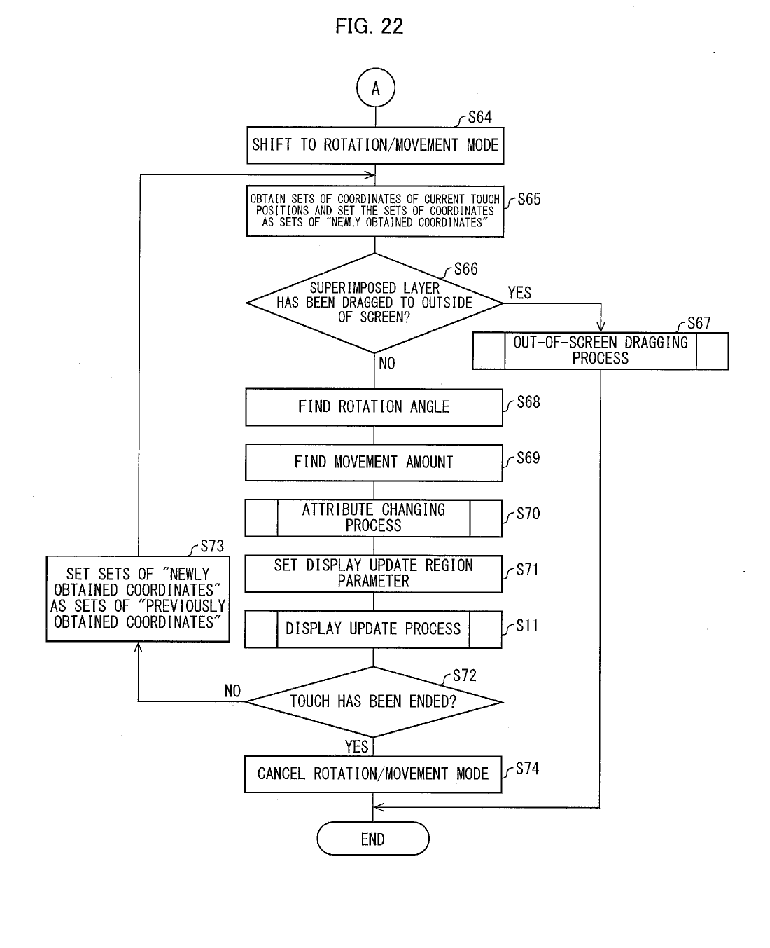

The following description discusses a two-finger touch operation handling process with reference to FIGS. 21 and 22. Each of FIGS. 21 and 22 is a flow chart showing an example of the two-finger touch operation handling process, and A in FIG. 21 is connected with A in FIG. 22. Note that the two-finger touch operation refers to an operation carried out by simultaneously touching a display surface with two fingers. As described earlier, the touch process or the scroll process is carried out by the touch operation with one finger. Meanwhile, movement or rotation of an object is carried out by the two-finger touch operation. Thus, according to the information processing device 1, different processes are carried out depending on the number of fingers for use in the operation.

First, the operation determination section 10 obtains, from the information notified by the input section 400, respective sets of coordinates of two points which have been touched, and then sets these sets of coordinates as sets of “previously obtained coordinates” (S60). Next, the operation determination section 10 determines, with reference to the map 32, whether an identical layer is touched with two fingers (S61).

Here, in a case where the operation determination section 10 has determined that an identical layer is not touched (NO at S61), the operation determination section 10 determines, with reference to the background layer management table 30, whether or not one of layers touched by the two fingers is a background layer (S75). Then, the operation determination section 10 which has determined that one of the layers is a background layer (YES at S75) determines that the normal touch operation has been carried out, and notifies the touch processing section 13 of sets of coordinates of touch positions so as to cause the touch processing section 13 to carry out the normal touch process (S3). With this, the two-finger touch operation handling process is ended. On the other hand, in a case where the operation determination section 10 has determined that one of the layers touched by the two fingers is not a background layer (NO at S75), that is, in a case where the two fingers have touched respective different superimposed layers, the operation determination section 10 notifies the layer-to-layer tying section 24 of this determination. Moreover, after the notification and while the two fingers are touching the respective different superimposed layers, the operation determination section 10 notifies the layer-to-layer tying section 24 of two touch positions. With this, the layer-to-layer tying section 24 carries out the layer-to-layer tying process (S76). Details of the layer-to-layer tying process will be described later.

Meanwhile, the operation determination section 10 which has determined that the identical layer is touched with the two fingers (YES at S61) determines whether or not the touch has been continued for a predetermined time period (S62). In a case where the touch is released before the predetermined time period passes (NO at S62), the operation determination section 10 notifies the magnification changing section 17 of (i) the sets of coordinates of the touch positions which have been touched until the touch is released and (ii) the layer which has been subjected to the touch operation, and causes the magnification changing section 17 to carry out a magnification changing process (S63). According to the magnification changing process, in order that a display is carried out at a display magnification in accordance with the notified sets of coordinates, the magnification changing section 17 updates data of the layer which has been subjected to the touch operation (data to be stored in the page data storing section 33 or the superimposed data storing section 34). Specifically, in a case where a so-called pinch-in operation has been carried out, the magnification changing section 17 updates the data so that a display image is reduced. Meanwhile, in a case where a pinch-out operation has been carried out, the magnification changing section 17 updates the data so that the display image is enlarged. The magnification changing section 17 sets a display update region parameter indicative of a region in which the data has been updated and notifies the display control section 18 that the display update region parameter has been set. Thereafter, the display control section 18 carries out the display update process (described earlier). With this, the image displayed in the display section 300 is updated, and the two-finger touch operation handling process is ended.

Meanwhile, the operation determination section 10 which has determined at S62 that the touch has been continued for the predetermined time period (YES at S62) gives the movement processing section 16 a notification of (i) the determination and (ii) the coordinates set at S60. The movement processing section 16 which has received the notification shifts to a rotation/movement mode (S64). The movement processing section 16 which has shifted to the rotation/movement mode displays a cursor prestored for the rotation/movement mode, instead of the cursor which had been displayed before the movement processing section 16 shifted to the rotation/movement mode.

Subsequently, the movement processing section 16 obtains sets of coordinates of current touch positions via the operation determination section 10, and then sets these sets of coordinates as sets of “newly obtained coordinates” (S65). Next, the operation determination section 10 determines a midpoint of the “newly obtained coordinates”, i.e., a midpoint of sets of coordinates indicating positions of the two fingers which are currently touching the display surface. Subsequently, the operation determination section 10 determines, with reference to the background layer management table, whether or not the midpoint has reached an edge region (i.e., outer edge region) of the background layer which edge region includes (i) a circumference and (ii) several inner pixels with respect to the circumference of the display update region of the background layer. With this, the operation determination section 10 determines whether or not the superimposed layer has been dragged to the outside of the screen (S66).

In a case where the operation determination section 10 has determined that the superimposed layer has been dragged to the outside of the screen (YES at S66), the operation determination section 10 notifies the background tying section 23 of this determination. Upon receipt of the notification, the background tying section 23 carries out the out-of-screen drag process (S67). Details of the out-of-screen drag process will be described later.

Meanwhile, in a case where the operation determination section 10 has determined that the superimposed layer has not been dragged to the outside of the screen (NO at S66), the movement processing section 16 finds, in accordance with (i) the sets of “previously obtained coordinates” notified by the operation determination section 10 and (ii) the sets of “newly obtained coordinates,” an angle at which to rotate the superimposed object (S68). Specifically, in a case where the sets of “previously obtained coordinates” and the sets of “newly obtained coordinates” include identical coordinates (sets of coordinates between which sets there exists a difference in value, the difference falling within a predetermined range can be considered as identical coordinates), the movement processing section 16 defines the identical coordinates as central coordinates. Then, the movement processing section 16 finds an angle formed by (i) a segment connecting the central coordinates and other coordinates of the sets of “previously obtained coordinates” and (ii) a segment connecting the central coordinates and other coordinates of the sets of “newly obtained coordinates”. Meanwhile, in a case where there exists no central coordinates, the movement processing section 16 finds a movement amount of the superimposed object in accordance with the sets of “previously obtained coordinates” and the sets of “newly obtained coordinates” (S69). Specifically, the movement processing section 16 calculates (i) coordinates of a midpoint between two sets of “previously obtained coordinates” and (ii) coordinates of a midpoint between two sets of “newly obtained coordinates,” and then calculates a distance between the coordinates (i) and the coordinates (ii). Then, the movement processing section 16 calculates a movement amount in accordance with the calculated distance and specifies a movement direction in accordance with a positional relationship between the coordinates (i) and the coordinates (ii). For example, the movement processing section 16 may specify the movement amount and the movement direction by each of which the superimposed object can move so as to follow the touch position.

Subsequently, the movement processing section 16 carries out the attribute changing process in accordance with the calculated movement amount so as to update attribute data in the map 32 (S70). Details of the attribute changing process will be described later. The movement processing section 16 sets a display update region parameter specifying a region including the superimposed layer which has not been moved and a region including the superimposed layer which has been moved (S71). Then, the movement processing section 16 notifies the display control section 18 of the setting of the display update region parameter, and causes the display control section 18 to carry out the display update process (described earlier) (S11).

In a case where the touch operation is being continued (NO at S72), the movement processing section 16 sets, as the sets of “previously obtained coordinates”, the sets of coordinates which sets were obtained at S65 and have been set as the sets of “newly obtained coordinates” before S71 (S73), and then carries out the process of S65 again. Meanwhile, in a case where the touch operation has been ended (YES at S72), the movement processing section 16 cancels the rotation/movement mode and replaces the cursor with the previously displayed cursor (S74). With this, the two-finger touch operation handling process is ended. The two-finger touch operation handling process allows a user to, while sliding two fingers with which the display surface is being touched, simultaneously move and rotate the superimposed object by drawing an ark with one of the two fingers by using the other one of the two fingers as a start point. This makes it possible for the user to promptly and smoothly carry out, through an intuitive operation, an input for displaying the superimposed object at a desired position in a desired direction.

Note that the method for determining whether or not the superimposed layer has been dragged to the outside of the screen is not limited to the above described example. For example, the movement processing section 16 can determine that the superimposed layer has been dragged to the outside of the screen based on a state where at least one set of coordinates contained in contour data of the superimposed object is not encompassed in the display update region of the background layer (i.e., a state where at least a part of the superimposed object is not displayed).

[Out-of-Screen Drag Process]

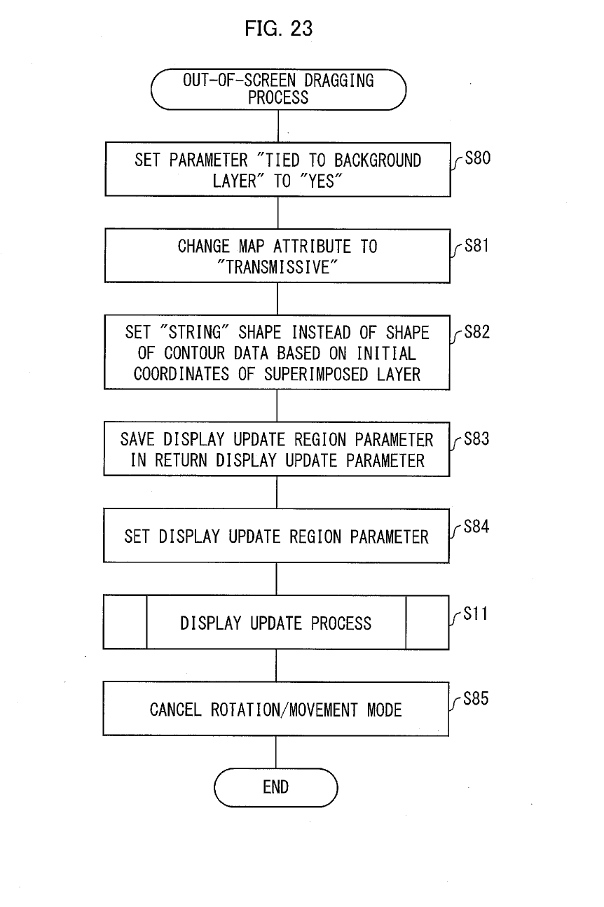

The following description discusses, with reference to FIG. 23, the out-of-screen drag process carried out at S67 of FIG. 22. FIG. 23 is a flow chart showing an example of the out-of-screen drag process. Note that the dragging to the outside of the screen is a drag operation in which the touch position reaches an end part of the display screen. By dragging the superimposed object to the outside of the screen, the superimposed object which has thus been moved to the end part of the display screen is hidden (i.e., not displayed).

First, upon receipt of the notification indicating that the superimposed layer has been dragged to the outside of the screen, the background tying section 23 sets, in the superimposed layer management table 31, the parameter “tied to background layer” of the superimposed layer corresponding to the dragged superimposed object to “YES” (S80). Then, the background tying section 23 changes a map attribute of pixels in the superimposed layer to “transmissive” (S81). Further, based on initial coordinates, the background tying section 23 sets a string shape instead of a shape indicated by contour data in the superimposed layer and changes a map attribute of pixels corresponding to the string shape to “string image” (S82). The attribute “string image” is one of the superimposed attributes, and a predetermined color is displayed in pixels having the attribute “string image”. Note that the initial coordinates (i) are reference coordinates obtained at a time point at which the superimposed layer has been generated and (ii) are prestored. The string shape is a shape whose (i) one end is at a position of a range specified to generate the superimposed object corresponding to the superimposed layer and (ii) another end is at a position (screen edge) at which the superimposed object has been last displayed. From this, a part from the position at which the range has been specified to the position at which the superimposed object has been hidden is displayed in the predetermined color, and this part is recognized as the string image.

Moreover, the background tying section 23 saves, in a return display update parameter, the display update region parameter of the position at which the superimposed object has been last displayed (S83). Further, the background tying section 23 sets a display update region parameter indicative of the region which has been set to have the string shape in S82 (S84), and notifies the display control section 18 of the update of the display update region parameter so as to cause the display control section 18 to carry out the display update process (S11). With this, a string image is displayed instead of the superimposed object. The background tying section 23 notifies the movement processing section 16 that the process has finished, and the movement processing section 16 which has received this notification cancels the rotation/movement mode and replaces the cursor with the previously displayed cursor (S85). With this, the out-of-screen drag process is ended.

With the above process, the string image, which indicates that the superimposed object has been dragged to the outside of the screen and is thus hidden, is displayed based on the initial coordinates. Moreover, the display update region parameter, which is indicative of the position at which the superimposed object was displayed immediately before being hidden, is recorded in the return display update parameter. With this, the superimposed object can be displayed again at the position. Note that the position at which the superimposed object is displayed again is not limited to the position at which the superimposed object has been last displayed. For example, a display update region parameter that is immediately before an operation (in this example, the drag operation) to hide the superimposed object is carried out can be recorded in the return display update parameter. In this case, the superimposed object can be displayed at a position at which the superimposed object has been displayed immediately before the drag operation is carried out. Alternatively, for example, a display update region parameter at an initial display position of the superimposed object (i.e., a position at which the superimposed object has been generated and displayed) can be recorded in the return display update parameter. In this case, the superimposed object can be displayed again at the initial display position.

[Attribute Changing Process]

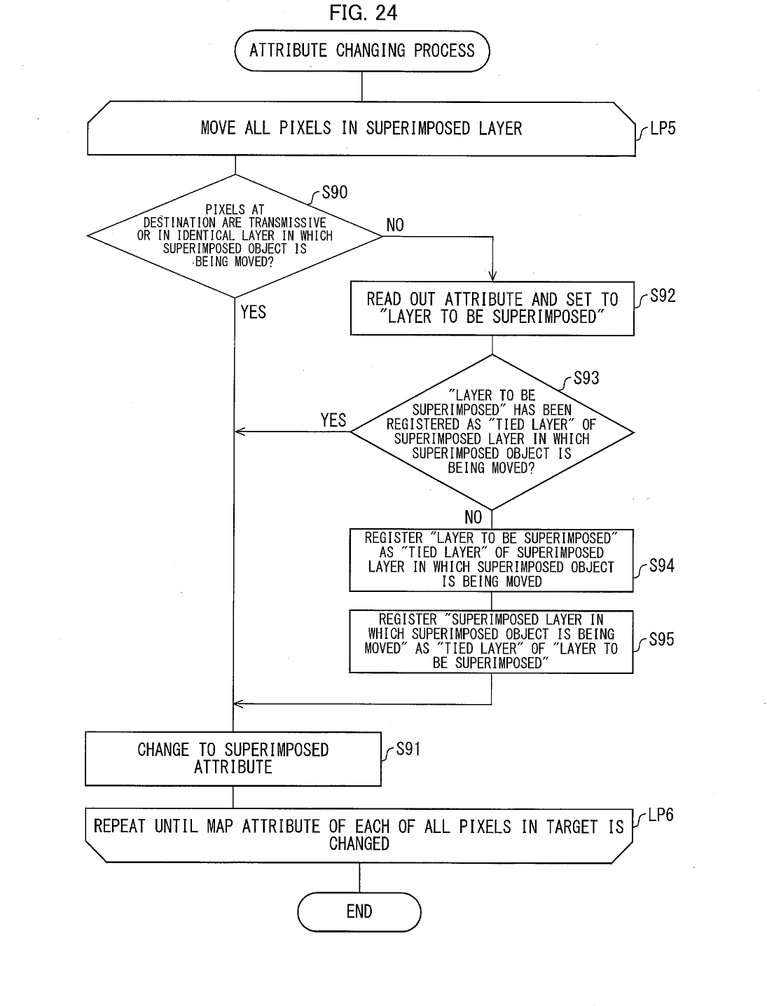

Next, the following description discusses, with reference to FIG. 24, the attribute changing process that is carried out at S70 in FIG. 22. FIG. 24 is a flow chart showing an example of the attribute changing process.

The movement processing section 16 which has calculated a movement amount of the superimposed object carries out processes from LP5 to LP6 with respect to all pixels at a destination of the superimposed object. First, the movement processing section 16 determines (i) whether or not a map attribute of a pixel at the destination is “transmissive” or (ii) whether or not the pixel at the destination is contained in a superimposed layer in which the superimposed object is being moved (S90). In a case where the map attribute of the pixel at the destination is “transmissive” or the pixel at the destination is contained in a superimposed layer in which the superimposed object is being moved (YES at S90), the movement processing section 16 changes the map attribute of the pixel at the destination into a superimposed attribute (S91), and carries out the process with respect to a next pixel.

On the other hand, in a case where the map attribute of the pixel at the destination is not “transmissive” and the pixel at the destination is contained in a superimposed layer that is different from the superimposed layer in which the superimposed object is being moved (NO at S90), the movement processing section 16 notifies the layer-to-layer tying section 24 of this determination. Upon receipt of the notification, the layer-to-layer tying section 24 sets the map attribute of the superimposed layer that is displayed in the pixel at the destination to “layer to be superimposed” (S92).

Then, the layer-to-layer tying section 24 determines, with reference to the superimposed layer management table 31, whether or not a layer to be superimposed is registered as a “tied layer” of the superimposed layer in which the superimposed object is being moved (S93).

Here, in a case where a layer to be superimposed has been registered as a “tied layer” of the superimposed layer in which the superimposed object is being moved (YES at S93), the layer-to-layer tying section 24 notifies the movement processing section 16 of this determination. Upon receipt of the notification, the movement processing section 16 changes the map attribute of the destination into a superimposed attribute that corresponds to the superimposed layer in which the superimposed object is being moved (S91), and carries out the process with respect to a next pixel.

On the other hand, in a case where no layer to be superimposed has been registered as a “tied layer” of the superimposed layer in which the superimposed object is being moved (NO at S93), the layer-to-layer tying section 24 registers the superimposed layer, which is different from the superimposed layer in which the superimposed object is being moved, as a “tied layer” of the superimposed layer which is included in the superimposed layer management table 31 and in which the superimposed object is being moved (S94). Similarly, the layer-to-layer tying section 24 registers the superimposed layer in which the superimposed object is being moved as a “tied layer” of the layer to be superimposed included in the superimposed layer management table 31 (S95), and notifies the movement processing section 16 of this registration. Upon receipt of the notification, the movement processing section 16 changes the map attribute of the pixel at the destination into a superimposed attribute corresponding to the superimposed layer in which the superimposed object is being moved (S91), and carries out the process with respect to a next pixel.

With the above process, in a case where a superimposed object has been moved to be superimposed on another superimposed object, these superimposed objects are tied to each other. That is, as illustrated in (b) of FIG. 5, the user can tie superimposed objects to each other by carrying out an operation to overlapping these superimposed objects with each other.

[Layer-to-Layer Tying Process]

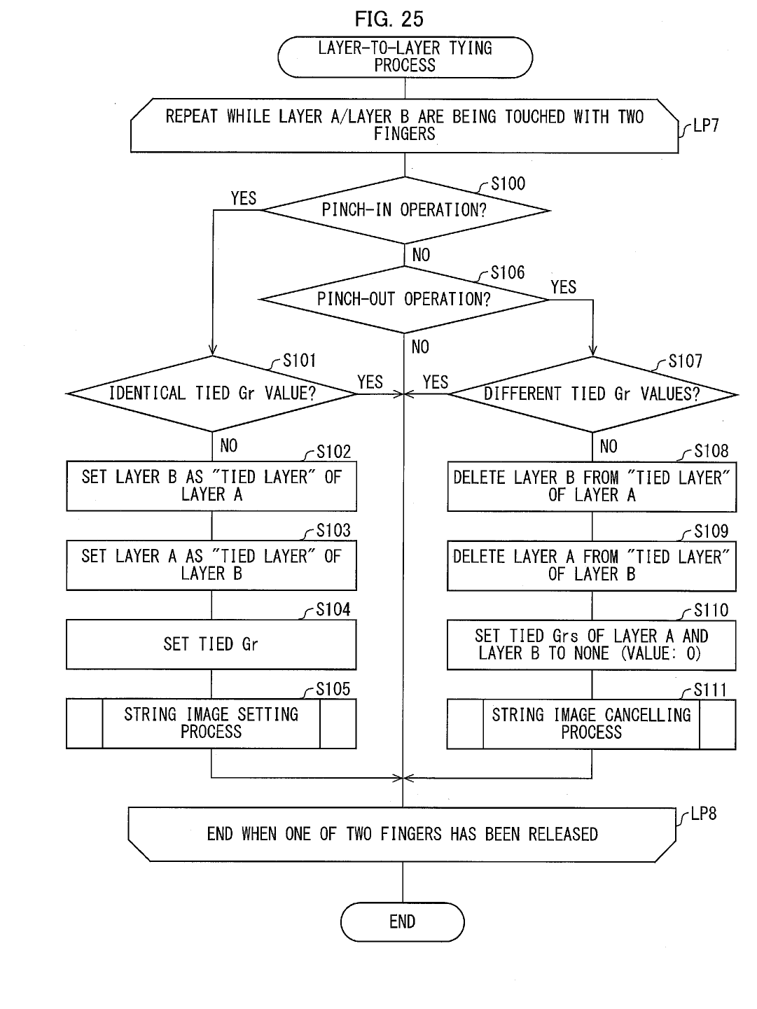

The following description discusses, with reference to FIG. 25, the layer-to-layer tying process that is carried out at S76 of FIG. 21. FIG. 25 is a flow chart showing an example of the layer-to-layer tying process.

The layer-to-layer tying section 24 which has received, from the operation determination section 10, a notification indicating that two fingers are touching respective different superimposed layers repeats processes from LP7 to LP8 while the operation determination section 10 is determining that a state continues where the two fingers are touching respective different superimposed layers. Note that, here, a superimposed layer which one of the two fingers touches is referred to as “layer A”, and a superimposed layer which the other of the two fingers touches is referred to as “layer B”.

First, the layer-to-layer tying section 24 determines, based on information which is indicative of touch positions and has been supplied from the operation determination section 10, whether or not a so-called pinch-in operation has been carried out (S100). In a case where the layer-to-layer tying section 24 has determined that the pinch-in operation has been carried out (YES at S100), the layer-to-layer tying section 24 determines whether or not the layers A and B belong to an identical tied group (S101). In a case where the layer-to-layer tying section 24 has determined that the layers A and B belong to an identical tied group (YES at S101), the layer-to-layer tying section 24 repeats the processes from LP7 to LP8 again, provided that the state continues where the two fingers are touching respective different superimposed layers.

On the other hand, in a case where the layer-to-layer tying section 24 has determined that the layers A and B belong to respective different tied groups (NO at S101), the layer-to-layer tying section 24 sets the layer B as a “tied layer” of the layer A included in the superimposed layer management table 31 (S102). Similarly, the layer-to-layer tying section 24 sets the layer A as a “tied layer” of the layer B included in the superimposed layer management table 31 (S103).

Then, the layer-to-layer tying section 24 sets a tied group (S104) and carries out a string image setting process (S105). Procedures for setting the tied group and the string image setting process will be described later. Moreover, in a case where a state continues where the two fingers are touching respective different superimposed layers after the process of S105 has been carried out, the processes from LP7 to LP8 are repeated again.

In a case where the layer-to-layer tying section 24 has not determined at S100 that the pinch-in operation has been carried out (NO at S100), the layer-to-layer tying section 24 determines, based on information which has been supplied from the operation determination section 10, whether or not a so-called pinch-out operation has been carried out (S106). In a case where the layer-to-layer tying section 24 has determined that the pinch-out operation has been carried out (YES at S106), the layer-to-layer tying section 24 determines whether or not the layers A and B belong to respective different tied groups (S107).

Here, in a case where the layers A and B belong to respective different tied groups (YES at S107), the layer-to-layer tying section 24 repeats the processes from LP7 to LP8 again, provided that the state continues where the two fingers are touching respective different superimposed layers. On the other hand, in a case where the layers A and B belong to an identical tied group (NO at S107), the layer-to-layer tying section 24 deletes the layer B from the “tied layer” of the layer A included in the superimposed layer management table 31 (S108). Similarly, the layer-to-layer tying section 24 deletes the layer A from the “tied layer” of the layer B included in the superimposed layer management table 31 (S109). Subsequently, the layer-to-layer tying section 24 sets the tied groups of the layer A and the layer B included in the superimposed layer management table 31 to none (value: 0) (S110), and then carries out a string image cancelling process (S111). After the process of S111 is carried out, the layer-to-layer tying section 24 repeats the processes from LP7 to LP8 again, provided that the state continues where the two fingers are touching respective different superimposed layers.

In a case where the layer-to-layer tying section 24 has not determined that the pinch-out operation has been carried out (NO at S106), the layer-to-layer tying section 24 repeats the processes from LP7 to LP8 again, provided that the state continues where the two fingers are touching respective different superimposed layers.

With the above process, as illustrated in (a) of FIG. 5, in a case where a pinch-in operation has been carried out while two superimposed objects which are not tied to each other are being touched, the two superimposed objects are tied to each other. Moreover, in a case where a pinch-out operation has been carried out while the two superimposed objects which are tied to each other are being touched, the two superimposed objects are untied.

[Setting of Tied Group]

The following description discusses procedures for setting of a tied group carried out at S104 of FIG. 25. In a case where tied groups are set to both the layers A and B, the tied groups are unified into a tied group of a smaller value. That is, a larger value of one of the two tied groups is updated with the smaller value. Moreover, in accordance with the change of the tied group, a priority list is also updated. That is, a state corresponding to the tied group (i.e., the tied group of the larger value) that is no longer used is updated with “Unused” in the priority list.

On the other hand, in a case where no tied group is set to both the layers A and B, an unused priority list number is obtained from the priority list table 39. Then, the number thus obtained is set as a tied group, to which the layers A and B belong, in each of the superimposed layer management tables 31 of the respective layers A and B.

Moreover, in a case where a tied group is set to only one of the layers A and B, a value of the tied group set to the one of the superimposed layers is set as a tied group of the other superimposed layer to which no tied group has been set.

[String Image Setting/Cancelling Process]

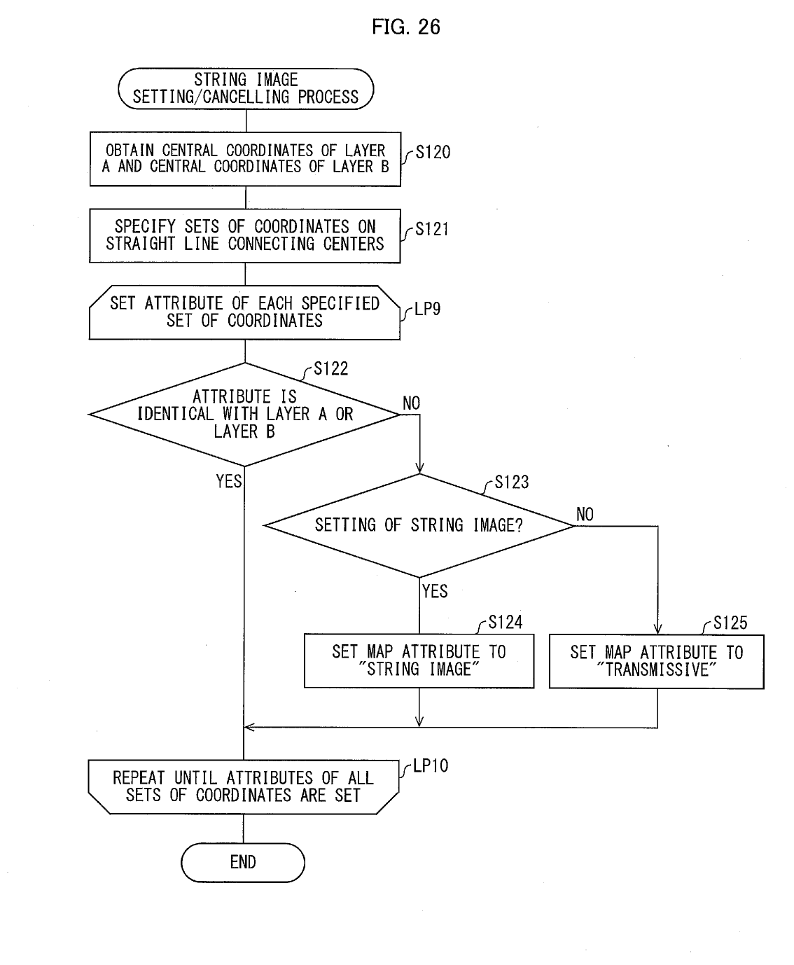

The following description discusses, with reference to FIG. 26, the string image setting process and the string image cancelling process which are carried out at respective S105 and S111 of FIG. 25. FIG. 26 is a flow chart showing an example of the string image setting/cancelling process.

First, the layer-to-layer tying section 24 obtains central coordinates of the layer A and central coordinates of the layer B, the layers A and B being superimposed layers touched by respective two fingers (S120). Note that the central coordinates (i) are central coordinates of a rectangle that surrounds a superimposed object corresponding to the superimposed layer and (ii) can be specified by referring to a display update region parameter in the superimposed layer management table 31. Subsequently, the layer-to-layer tying section 24 specifies sets of coordinates on a straight line with which the obtained sets of central coordinates are connected to each other (S121).

Next, the layer-to-layer tying section 24 carries out processes from LP9 to LP10 with respect to the coordinates thus specified. First, the layer-to-layer tying section 24 determines whether or not a map attribute of coordinates subjected to the processes is identical with a map attribute of the layer A or B, i.e., whether or not a value of the map attribute indicates the layer A or B (S122). In a case where the map attribute is identical with the attribute of the layer A or B (YES at S122), the processes from LP9 to LP10 are carried out with respect to a next set of coordinates.

On the other hand, in a case where the map attribute is not identical with any of the attributes of the layers A and B (NO at S122), the layer-to-layer tying section 24 determines whether or not a process to be carried out is setting a string image (S123). That is, the layer-to-layer tying section 24 determines whether a process to be carried out is the string image setting process or the string image cancelling process. In a case where the layer-to-layer tying section 24 has determined that the process to be carried out is setting of the string image (YES at S123), i.e., the process is the string image setting process, the layer-to-layer tying section 24 sets the map attribute of the coordinates subjected to the processes to “string image” (S124), and then carries out the processes from LP9 to LP10 with respect to a next set of coordinates.

On the other hand, in a case where the layer-to-layer tying section 24 has determined that the process to be carried out is not setting of the string image (NO at S123), i.e., the process is the string image cancelling process, the layer-to-layer tying section 24 sets the map attribute of the coordinates subjected to the processes to “transmissive” (S124), and then carries out the processes from LP9 to LP10 with respect to a next set of coordinates.

As such, according to the string image setting process, a string image is displayed so as to connect the layer A to the layer B. Moreover, according to the string image cancelling process, the string image connecting the layer A to the layer B is deleted. Note that the straight line (i.e., the straight line indicating the sets of coordinates at which the string image is displayed) determined by the processes at S120 and S121 can be replaced with a curved line. Moreover, end-points of the straight line or the curved line can be respective of (i) any point included in the superimposed object in the layer A and (ii) any point included in the superimposed object in the layer B.

[Keyword Display Process]

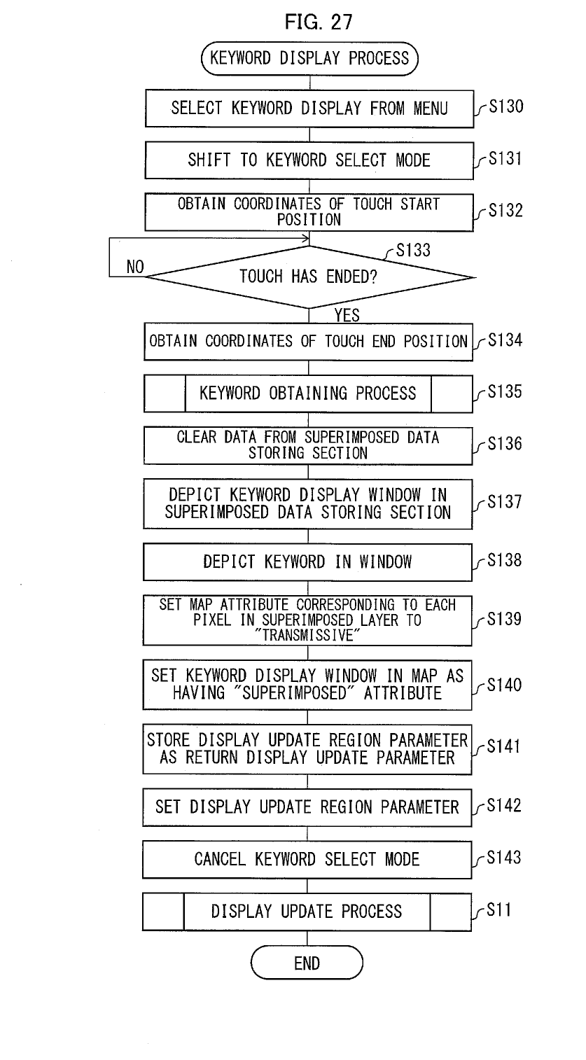

The following description discusses, with reference to FIG. 27, the keyword display process of displaying a keyword object instead of a superimposed object. FIG. 27 is a flow chart showing an example of the keyword display process.

In a case where the operation determination section 10 has determined that an operation to select a keyword display from a menu of a certain superimposed object has been carried out (S130), the operation determination section 10 notifies the keyword display section 25 of this determination so as to shift the keyword display section 25 to a keyword select mode (S131). In the keyword select mode, the keyword display section 25 obtains coordinates of a touch start position from sets of coordinates of touch positions supplied from the operation determination section 10 (S132), and waits for end of the touch (S133).

In a case where the keyword display section 25 has determined that the touch has been ended (YES at S133), the keyword display section 25 obtains coordinates of a touch end position (i.e., coordinates last received from the operation determination section 10) (S134). Subsequently, the keyword display section 25 carries out the keyword obtaining process based on the obtained sets of coordinates of the touch start position and the touch end position (S135). Details of the keyword obtaining process will be described later.

Next, the keyword display section 25 clears, from the superimposed data storing section 34, data of the superimposed object that is to be replaced with keyword display (S136). Subsequently, the keyword display section 25 generates a keyword display window and depicts the keyword display window in the superimposed data storing section 34 (S137), and depicts, in the keyword display window, the keyword obtained at S135 (S138). Further, the keyword display section 25 sets a map attribute corresponding to pixels in the superimposed layer to “transmissive” (S139), and then sets a map attribute corresponding to pixels corresponding to the keyword display window thus depicted to “superimposed” (S140).

Moreover, in the superimposed layer management table 31, the keyword display section 25 sets a display update region parameter of the superimposed layer to a return display update parameter (S141), and then sets a rectangular region including the keyword display window as a display update region parameter (S142). Subsequently, the keyword display section 25 cancels the keyword select mode (S143) and notifies the display control section 18 of update of the display update region parameter, and the display control section 18 carries out the display update process (S11). Thus, the keyword display process is ended.

By the above processes, the user can change the superimposed object into the keyword display. Moreover, the display position of the superimposed object is stored in the return display update parameter, and it is therefore possible to display, with reference to the parameter, the superimposed object again at the position before being changed to the keyword display.

In the above example, the keyword obtaining process is carried out in response to the operation to select the keyword display from the menu. Note, however, that the keyword obtaining process can be carried out before such an operation is carried out. In this case, the processes at S131 through S135 are omitted. Moreover, the superimposed object to be replaced with the keyword display can include (i) only the superimposed object on which the menu has been displayed or (ii) such a superimposed object and another superimposed object which is tied to this superimposed object.

[Keyword Obtaining Process]

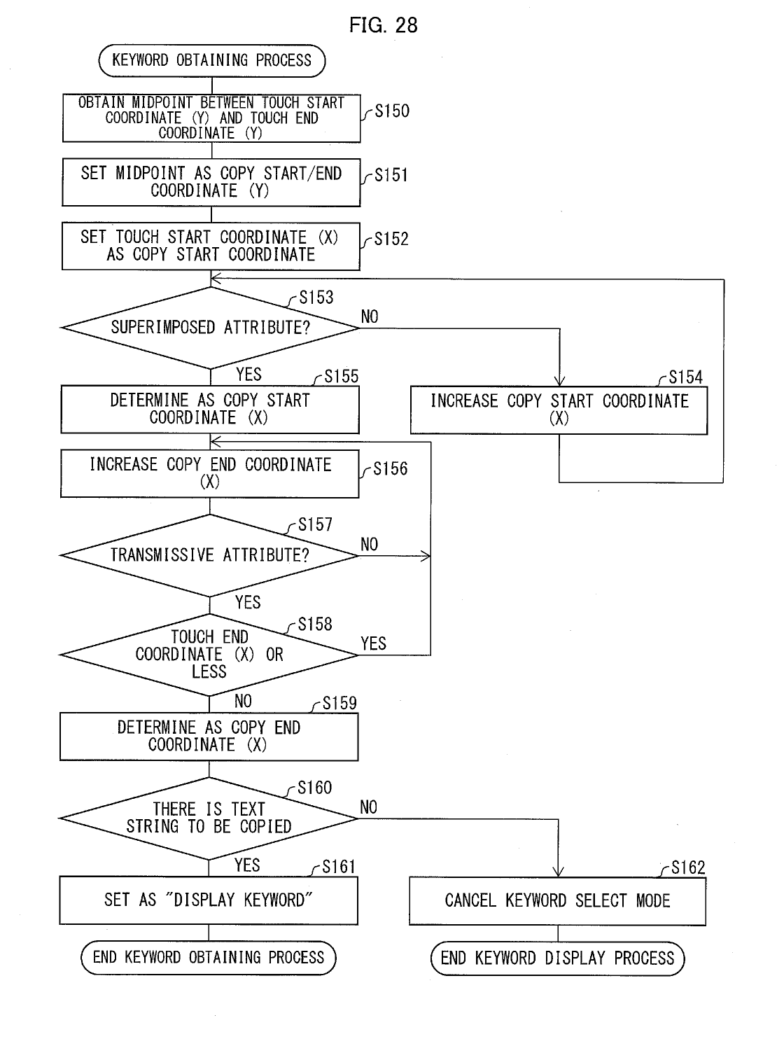

Next, the following description discusses, with reference to FIG. 28, the keyword obtaining process carried out at S135 in FIG. 27. FIG. 28 is a flow chart showing an example of the keyword obtaining process. Here, an x component of coordinates is referred to as “coordinate (x)” and a y component of coordinates is referred to as “coordinate (y)”.

First, the keyword display section 25 obtains a coordinate of a midpoint between a touch start coordinate (y) which is a y coordinate of the touch start position and a touch end coordinate (y) which is a y coordinate of the touch end position (S150). Then, the keyword display section 25 sets the coordinate of the midpoint thus obtained to a y coordinate serving as a reference coordinate of start and end of copying (S151).

Moreover, the keyword display section 25 set an x coordinate of the touch start position to a copy start coordinate (x) (S152). By the processes at S151 and S152, the x and y coordinates of the copy start position are determined. Then, the keyword display section 25 determines whether or not a map attribute of the copy start coordinates is “superimposed” (S153). In a case where the keyword display section 25 has determined that the map attribute of the copy start coordinates is not “superimposed” (NO at S153), the keyword display section 25 increases the copy start coordinate (x) by a certain value (e.g., 1) (S154), and determines again whether or not the map attribute of the copy start coordinates is “superimposed” (S153).

On the other hand, in a case where the keyword display section 25 has determined that the map attribute of the copy start coordinates is “superimposed” (YES at S153), the keyword display section 25 determines the current copy start coordinate (x) as a copy start coordinate (x) (S155). Further, the keyword display section 25 sets the copy start coordinate (x) as an initial value of a copy end coordinate (x).

Subsequently, the operation determination section 10 increases the copy end coordinate (x) by a certain value (e.g., 1) (S156), and determines whether or not a map attribute of the copy end coordinates is “transmissive” (S157). In a case where the operation determination section 10 has determined that the map attribute of the copy end coordinates is not “transmissive” (NO at S157), the process returns to S156.

On the other hand, in a case where the operation determination section 10 has determined that the map attribute of the copy end coordinates is “transmissive” (YES at S157), the keyword display section 25 determines whether or not the copy end coordinate (x) is equal to or smaller than the touch end coordinate (x) (S158). In a case where the copy end coordinate (x) is equal to or smaller than the touch end coordinate (x) (YES at S158), the process returns to S156.

On the other hand, in a case where the copy end coordinate (x) is not equal to or smaller than the touch end coordinate (x), that is, the copy end coordinate (x) is equal to the touch end coordinate (x) (NO at S158), the keyword display section 25 determines the current copy end coordinate (x) as an ultimate copy end coordinate (x) (S159).

Subsequently, the keyword display section 25 determines whether or not there is a text string to be copied in a range between the copy start coordinates and the copy end coordinates (S160). In a case where there is a text string to be copied (YES at S160), the keyword display section 25 sets the text string as a display keyword in the superimposed layer management table 31 (S161), and ends the keyword obtaining process.

On the other hand, in a case where there is no text string to be copied in the range between the copy start coordinates and the copy end coordinates (NO at S160), the keyword display section 25 cancels the keyword select mode (S162) and ends the keyword display process.

By the above processes, the text string between the touch start position and the touch end position on the superimposed object is set as a keyword in the keyword select mode. Moreover, the copy start coordinate (y) is identical with the copy end coordinate (y), and therefore, among text strings on the superimposed object, only the text string that is contained in one line corresponding to the position specified on the superimposed object is subjected to the keyword setting.

[Detail Display Process]

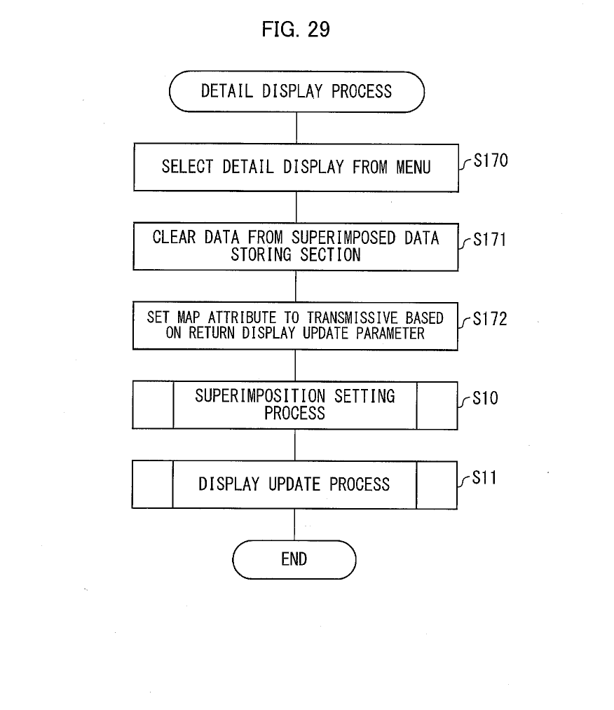

Next, the following description discusses, with reference to FIG. 29, the detail display process that is a process of returning a superimposed object from a keyword display state to a detail display state. FIG. 29 is a flow chart showing an example of the detail display process.

First, in a case where the operation determination section 10 has determined that an operation to select detail display from the menu (i.e., an operation to select an item “keyword display/detail display” from the menu displayed on the keyword object) has been carried out (S170), the operation determination section 10 notifies the keyword display section 25 with this determination. Upon receipt of the notification, the keyword display section 25 clears data that corresponds to the keyword object and is stored in the superimposed data storing section 34 (S171). Subsequently, the keyword display section 25 sets a map attribute to “transmissive” based on a display update region parameter (S172). With this, the keyword display window is hidden. Moreover, the keyword display section 25 instructs the superimposed display processing section 12 to display the superimposed object corresponding to the keyword object again.

After that, the superimposed display processing section 12 carries out the superimposition setting process with respect to the superimposed object (S10), and then the display control section 18 carries out the display update process (S11). With this, the superimposed object is displayed again, and the detail display process is ended.

[Priority Setting Process]

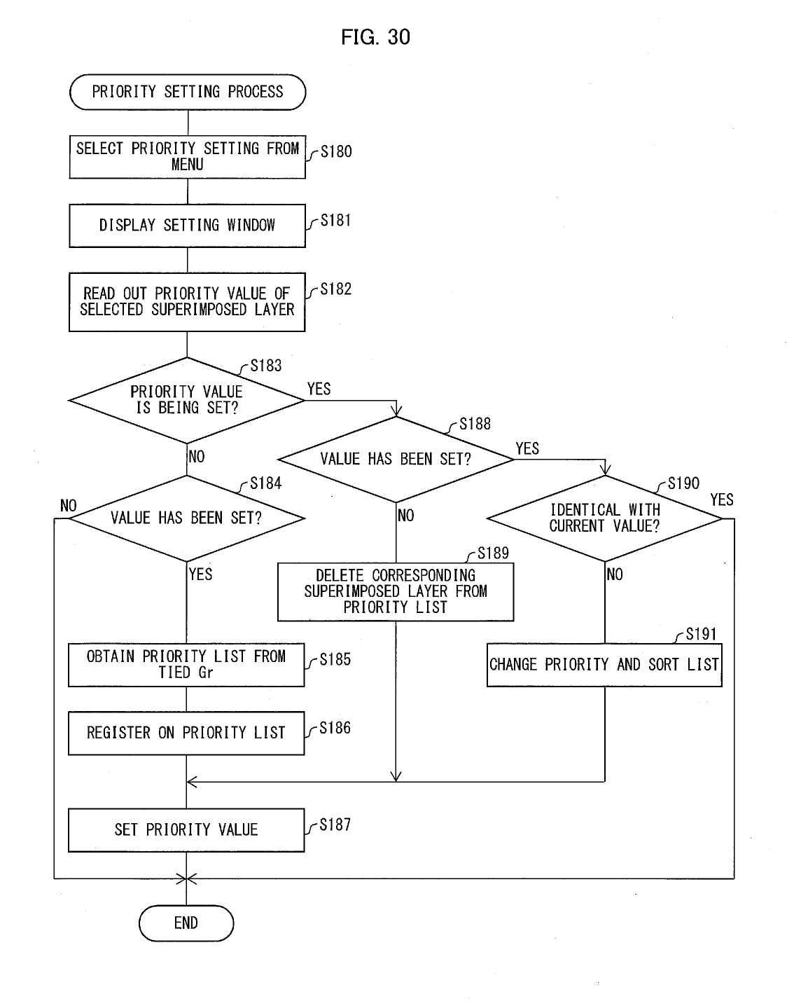

The following description discusses, with reference to FIG. 30, the priority setting process of setting priorities for sorting superimposed objects. FIG. 30 is a flow chart showing an example of the priority setting process.

In a case where the operation determination section 10 has determined that the item “priority setting” has been selected from the menu (S180), the operation determination section 10 notifies the priority display processing section 26 of this determination. Upon receipt of the notification, the priority display processing section 26 causes a setting window to be displayed (S181). The setting window is a user interface for setting a priority value to a selected superimposed layer (i.e., a superimposed layer corresponding to a superimposed object on which the menu is displayed). Next, the priority display processing section 26 attempts to read out a priority value of the selected superimposed layer from the superimposed layer management table 31 (S182), and determines whether or not a priority value is being set (S183).

Here, in a case where the priority display processing section 26 has determined that a priority value is not being set (NO at S183), the priority display processing section 26 determines whether or not a priority value has been set on the setting window (S184). In a case where no priority value has been set (NO at S184), the priority setting process is ended. On the other hand, in a case where a priority value has been set (YES at S184), the priority display processing section 26 obtains, from the priority list table 39, a priority list corresponding to a tied group to which the selected superimposed layer belongs (S185).

Subsequently, the priority display processing section registers the selected superimposed layer on the obtained priority list based on the priority value which has been set (S186). Specifically, the priority display processing section 26 registers the selected superimposed layer so that a sort order of the obtained priority list becomes an order of priority values. Moreover, the priority display processing section 26 sets the priority value, which has been set, in the superimposed layer management table 31 (S187), and the priority setting process is ended.

Here, in a case where the priority display processing section 26 has determined that a priority value is being set (YES at S183), the priority display processing section 26 determines whether or not a priority value has been set on the setting window (S188). In a case where no priority value has been set (NO at S188), the priority display processing section 26 deletes the selected superimposed layer from the priority list (S189). Then, processes at and subsequent to S187 are carried out.

In a case where a priority value has been set (YES at S188), the priority display processing section 26 determines whether or not the priority value which has been set is identical with a current value (i.e., the value read out at S182) (S190). In a case where the priority display processing section 26 has determined that the priority value which has been set is identical with the current value (YES at S190), the priority display processing section 26 ends the priority setting process. On the other hand, in a case where the priority display processing section 26 has determined that the priority value which has been set is not identical with the current value (NO at S190), the priority display processing section 26 sorts the priority list based on the priority value which has been set (S191). After that, processes at and subsequent to S187 are carried out.

With the above processes, the priority value which has been set is set in the superimposed layer management table 31. Moreover, the sort order included in the priority list table 39 remains being based on the priority value in the superimposed layer management table 31.

[Sorting Process]

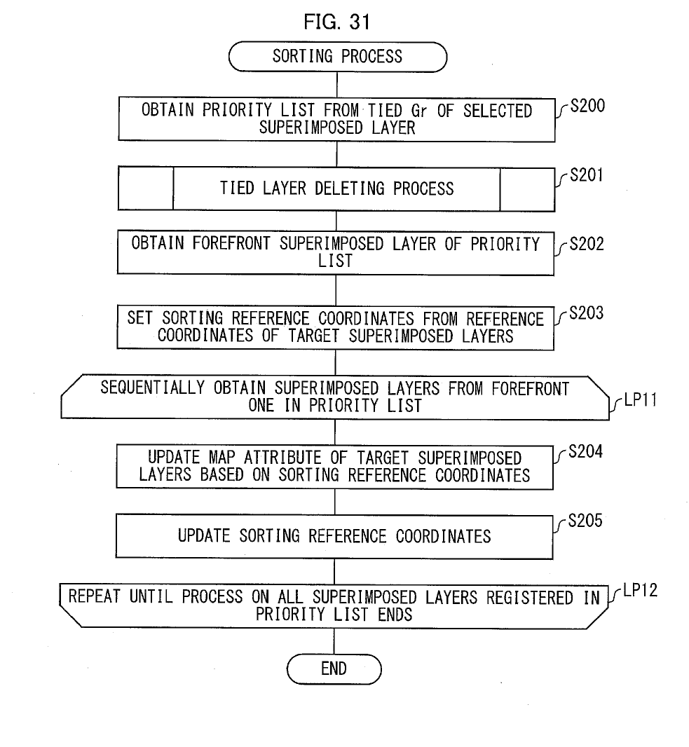

The following description discusses, with reference to FIG. 31, the sorting process of sorting superimposed objects (superimposed layers) in accordance with a priority list. FIG. 31 is a flow chart illustrating an example of the sorting process. Note that the sorting process is carried out when the operation determination section 10 has notified the priority display processing section 26 that sorting has been selected from the menu on the selected superimposed object (superimposed layer).

First, the priority display processing section 26 obtains, from the priority list table 39, a priority list corresponding to a tied group to which the selected superimposed layer belongs (S200), and carries out a tied layer deleting process (S201). Details of the tied layer deleting process will be described later.

After the tied layer deleting process is ended, the priority display processing section 26 obtains a superimposed layer that is in the forefront of the sort order in the priority list (S202). Subsequently, the priority display processing section 26 sets sorting reference coordinates from reference coordinates of the superimposed layers to be sorted (S203). For example, among the superimposed layers in the sort order in the priority list, reference coordinates of a superimposed layer in which an x coordinate and a y coordinate are both smallest (i.e., a superimposed layer corresponding to a superimposed object that is nearest to an upper left corner of the screen) can be set as the sorting reference coordinates.

Subsequently, the priority display processing section 26 carries out processes from LP11 to LP12 with respect to superimposed layers which are in the priority list and have been obtained in the sort order. First, the priority display processing section 26 updates a map attribute of a target superimposed layer based on the sorting reference coordinates (S204). Specifically, the priority display processing section 26 sets the sorting reference coordinates as reference coordinates of the target superimposed layer, and updates a map attribute of a region indicated by a display update region parameter that is based on the reference coordinates. Moreover, the priority display processing section 26 updates the sorting reference coordinates (S205). For example, the sorting reference coordinates can be reference coordinates of a superimposed layer that corresponds to a superimposed object which is second nearest to the upper left corner of the screen among the superimposed layers in the sort order in the priority list. Alternatively, for example, the sorting reference coordinates can be updated by adding a width of the target superimposed layer and a predetermined value to an x component of sorting reference coordinates so that the superimposed objects are sequenced from a left end of the screen. After that, the priority display processing section 26 carries out the processes from LP11 to LP12 with respect to a next superimposed layer (as a target superimposed layer) in the priority list.

By the above processes, the superimposed layers which are tied to each other are sequenced in accordance with the set priority values. Note that a direction in which the superimposed layers are sequenced can be changed as appropriate. Moreover, as in the example shown in (b) of FIG. 9, display of a string image can also be updated so that the string image is displayed between adjacent superimposed objects.

[Tied Layer Deleting Process]

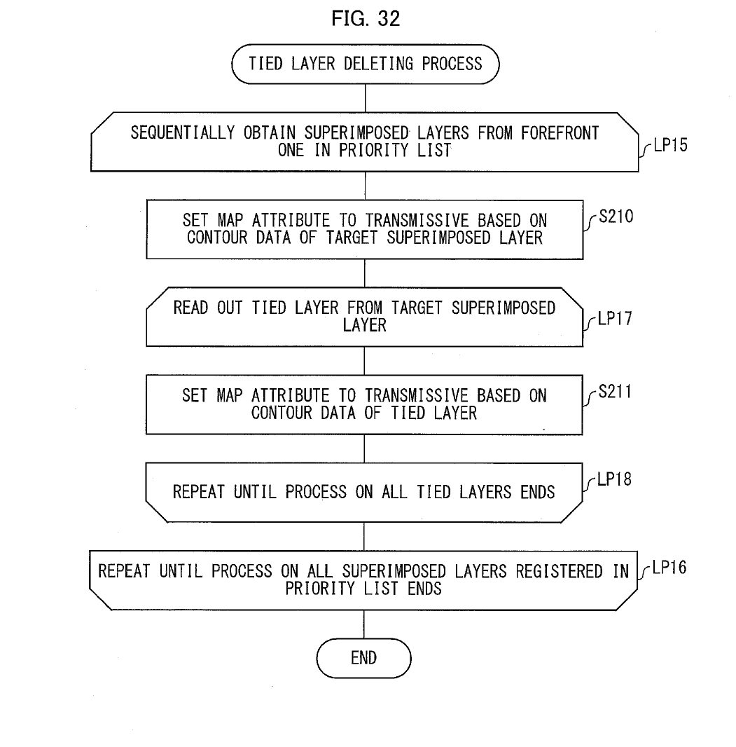

Next, the following description discusses, with reference to FIG. 32, the tied layer deleting process that is carried out at S201 of FIG. 31. FIG. 32 is a flow chart showing an example of the tied layer deleting process.

The priority display processing section 26 which has obtained the priority list carries out processes from LP15 to LP16 sequentially with respect to superimposed layers included in the priority list, from a forefront one in the sort order. First, the priority display processing section 26 sets a map attribute of pixels corresponding to sets of coordinates included in contour data of a target superimposed layer to “transmissive” (S210).

Next, the priority display processing section 26 reads out, from the superimposed layer management table 31, superimposed layers that are tied to the target superimposed layer, and the priority display processing section 26 carries out processes from LP17 to LP18 with respect to each of the superimposed layers thus read out. That is, the priority display processing section 26 carries out, with respect to each of the superimposed layers thus read out, a process of setting a map attribute of pixels corresponding to coordinates included in contour data of superimposed layers tied to the target superimposed layer to “transmissive” (S211). After that, if there is another superimposed layer registered in the priority list, the priority display processing section 26 carries out the processes at and subsequent to S210 with respect to the another superimposed layer.

By the above processes, the selected superimposed layer and the superimposed layers which are directly or indirectly tied to the selected superimposed layer are all hidden.

### Embodiment 2

In Embodiment 1, the example is shown in which the string image is displayed as notification information indicative of an original position of the hidden superimposed object in the background layer. However, the notification information is not limited to this example, provided that the notification information is information by which the user can recognize the original position of the superimposed object in the background layer. For example, the presence of a hidden superimposed object and a position (i.e., a position in a specified range) on content corresponding to the hidden superimposed object can be indicated by a character, a sign, or the like. Note, however, that a linear image like a string image allows the user to recognize both (i) an original position of the hidden superimposed object on content (background layer) and (ii) a position at which the hidden superimposed object has been dragged to the outside of the screen. Moreover, the notification information is preferably a linear image because such a linear image occupies only a small area on the display screen and hardly interferes with browsing of a web page in the background. The same applies to the information which indicates that superimposed objects are tied to each other, and such information is preferably, but not limited to, a linear image like a string image.

In Embodiment 1, the example is shown in which, in a case where a superimposed object has been dragged to the outside of the screen, the parameter “tied to background layer” corresponding to the superimposed object in the superimposed layer management table 31 is updated to “YES”. Note, however, that a trigger of the update is not limited to this example. For example, the parameter can be updated to “YES” when the user has carried out a predetermined operation (e.g., an operation to simultaneously touch a superimposed object and a web page in the background). In this case, it is possible that (i) a string image is displayed if the parameter is “YES” when the superimposed object is hidden by being dragged to the outside of the screen or the like and (ii) display of the superimposed object is ended without displaying a string image if the parameter is NO when the superimposed object is hidden by being dragged to the outside of the screen or the like. This makes it possible to selectively display a string image only for a superimposed object which the user wants to view again.

According to the information processing device 1, how to specify the input operation is not limited to the example described earlier, but may be determined in accordance with, for example, specifications of the device. For example, according to the example described earlier, the superimposed object is moved or rotated with two fingers. Alternatively, the superimposed object can be moved or rotated with one finger.

The above description has shown an example in which a superimposed object is displayed in a web page. Note, however, that content on which the superimposed object is to be displayed is not limited to the web page, provided that the content is displayed in units of pages. For example, the information processing device 1 which is an electronic dictionary can (i) display an image in accordance with data in a format such as an XMDF format and (ii) display a superimposed object so that the superimposed object is superimposed on the displayed image, the superimposed object corresponding to a range specified in the displayed image. Alternatively, the information processing device 1 which is a device capable of displaying an electronic book can (i) display an image in accordance with data in a format such as an EPUB format and (ii) display a superimposed object so that the superimposed object is superimposed on the displayed image, the superimposed object corresponding to a range specified in the displayed image. As in the case of HTML content, such data includes, for example, (i) elements (text and an image or respective reference destinations of the text and the image) constituting the content, (ii) arrangement information for arranging these elements on a screen, and (iii) a tag indicative of a link. This allows a process similar to that of Embodiment 1 to (i) receive, separately from an original web page, an input operation carried out by a user and (ii) display a superimposed object in which a result of the input operation is reflected.

For content other than the web page, a display state in which a superimposed object is displayed can be reproduced by subjecting the content to a process similar to the bookmark process (described earlier) and storing a first piece of information and a second piece of information so that the first piece of information and the second piece of information are associated with each other, the first piece of information being information for accessing the content on which the superimposed object is based, the second piece of information being information indicative of a specified range. For example, some devices for displaying an electronic book or an electronic dictionary have a function of inserting a “bookmark” for displaying content from a page that a user is reading. According to such a device, in a case where an operation to insert the “bookmark” is carried out while a superimposed object is being displayed, it is possible to store a first piece of information and a second piece of information so that the first information and the second piece of information are associated with each other, the first piece of information being information indicative of a page on which the superimposed object being displayed is based, and the second piece of information being information indicative of a range of the superimposed object. When the user carries out an operation to open the page of the “bookmark”, the stored first and second pieces of information can be used not only to display the page into which the “bookmark” has been inserted but also to display the superimposed object so that the superimposed object is superimposed on the page.

Note that the information processing device 1, which basically assumes that a user browses content but does not assume that the user edits the content, may display content that is not to be edited (content that is exclusively used for browsing).

The above description has shown an example in which content (a web page) obtained via a communication network is displayed. Note, however, that a destination from which content is obtained is not particularly limited. For example, content stored in the storage section 200 may be displayed. Alternatively, content obtained from a storage medium such as a memory card which stores therein the content may be displayed by connecting the storage medium to the information processing device 1.

### Embodiment 3

A control block (especially, the control section 100) of the information processing device 1 can be realized by a logic circuit (hardware) provided in an integrated circuit (IC chip) or the like or can be alternatively realized by software as executed by a CPU (Central Processing Unit).

In the latter case, the information processing device 1 includes a CPU that executes instructions of a program that is software realizing the foregoing functions; ROM (Read Only Memory) or a storage device (each referred to as “recording medium”) in which the program and various kinds of data are stored so as to be readable by a computer (or a CPU); and RAM (Random Access Memory) in which the program is loaded. An object of the present invention can be achieved by a computer (or a CPU) reading and executing the program stored in the recording medium. Examples of the recording medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

[Main Points]

An information processing device (1) in accordance with an aspect 1 of the present invention is an information processing device for displaying content, the information processing device (1) including: a superimposed displaying section (superimposed display processing section 12) for causing a superimposed object to be displayed so that the superimposed object is superimposed on the content, the superimposed object containing an image in a range specified on the content which is displayed; and an information displaying section (background tying section 23) for causing notification information to be displayed in a state where the superimposed object is temporarily hidden, the notification information being indicative of a position of the range on the content.

According to the configuration, the superimposed object is displayed while being superimposed on the content. Further, in the state where the superimposed object is hidden, the notification information indicative of a position of the range (in which an image included in the superimposed object) on the content is displayed while being superimposed on the content.

In this case, even in the state where the superimposed object is temporarily hidden, the user can recognize the presence of the superimposed object corresponding to the position indicated by the notification information. With this, the user can browse the content while taking into consideration the position of the corresponding superimposed object on the content even in the non-display state, and the user can cause the corresponding superimposed object to be displayed again at an intended timing and at an intended position.

Note that, in the state where the superimposed object is temporarily hidden, the notification information does not need to be constantly displayed. For example, the notification information can be exceptionally hidden when the superimposed object is hidden by scrolling of the screen or the like. Moreover, the notification information does not need to be constantly displayed while the superimposed object is temporarily hidden. Note that the state where the superimposed object is temporarily hidden indicates a state in which the superimposed object is not display during the state but can be displayed again.

According to the information processing device in accordance with an aspect 2 of the present invention, it is possible in the aspect 1 that the superimposed displaying section causes the superimposed object to be displayed again in response to an operation carried out with respect to the notification information.

According to the configuration, the superimposed object is displayed again in response to an operation carried out with respect to the notification information. With this, the user can (i) recognize the presence of the superimposed object by the notification information and (ii) cause the superimposed object to be displayed again by an intuitive and smooth operation, i.e., an operation carried out with respect to the notification information.

According to the information processing device in accordance with an aspect 3 of the present invention, it is possible in the aspect 1 or 2 that the superimposed displaying section causes the superimposed object to be temporarily hidden when the superimposed object has been moved to an end part of a display screen; and the notification information further indicates a position of the end part to which the superimposed object has been moved.

With this, the user can temporarily hide the superimposed object by an intuitive operation of moving the superimposed object to the end part of the display screen. Moreover, since the notification information further indicates the position to which the superimposed object has been moved to be temporarily hidden, the user can easily recall the sequential operations from displaying the superimposed object to temporarily hiding the superimposed object.

The notification information can be a linear image that connects a point in the range with the end part, and the operation to display the superimposed object again can be an operation to drag the linear image. With this, the user can cause the hidden superimposed object to be displayed again by an intuitive operation, i.e., as if by pulling out the superimposed object which has been taken away to the outside of the screen.

The information processing device in accordance with an aspect 4 of the present invention can include, in any one of the aspects 1 through 3, a batch processing section (copy section 20 and the like) for carrying out a certain process on one of a plurality of superimposed objects and on another one of the plurality of superimposed objects which is associated with the one of the plurality of superimposed objects, each of the plurality of superimposed objects being the above superimposed object and being caused to be displayed by the superimposed displaying section.

According to the configuration, by associating a plurality of superimposed objects with each other and carrying out a certain process with respect to one of the plurality of superimposed objects, the certain process can be carried out with respect to also the other superimposed objects associated with that superimposed object. That is, the certain process can be collectively carried out with respect to the plurality of superimposed objects. The certain process can be, for example, moving a display position, registering a bookmark, recording an image, copying a text, or the like.

Note that, in a case where the certain process is recording of an image, it is preferable to record, along with images of a plurality of superimposed objects associated with each other, information indicating that the plurality of superimposed objects are associated with each other. This makes it possible to recognize, from the recorded image, that the plurality of superimposed objects are associated with each other.

The information processing device in accordance with an aspect 5 of the present invention can include, in any one of the aspects 1 through 4, a keyword displaying section (keyword display section 25) for causing a text string which is associated with the superimposed object to be displayed instead of the superimposed object.

According to the configuration, the text string is displayed instead of the superimposed object, and therefore it is possible to reduce an amount of information to be superimposed on the content and to improve viewability of the content. Moreover, the text string to be displayed is a text string associated with the superimposed object, and therefore the user can recognize, based on the text string, which superimposed object has been displayed.

The information processing device in accordance with an aspect 6 of the present invention can include, in the aspect 5, a keyword setting section (keyword display section 25) for obtaining, from a line specified on the superimposed object, a text string to be associated with the superimposed object.

According to the configuration, the text string to be associated with the superimposed object is obtained from a line specified on the superimposed object. In this configuration, a text string across a plurality of lines will not be obtained, and therefore, even in a case where the user has mistakenly specified a position across a plurality of lines, a text string can be obtained from one line. This is particularly beneficial for a case where specification of a position is carried out by a touch operation with respect to a small display screen (i.e., small characters).

The information processing device in accordance with an aspect 7 of the present invention can include, in any one of the aspects 1 through 6, a sorting section (priority display processing section 26) for sorting two or more of a plurality of superimposed objects in accordance with a predetermined priority, the two or more of the plurality of superimposed objects being associated with each other, and each of the plurality of superimposed objects being the above superimposed object and being caused to be displayed by the superimposed displaying section. According to the configuration, the superimposed objects which are associated with each other are sorted in order of priority, and it is therefore easy to adjust an arrangement order of the plurality of superimposed objects.

The information processing device in accordance with the aspects of the present invention may be realized by a computer. In this case, the present invention encompasses: a control program for the information processing device which program causes a computer to operate as the foregoing sections of the information processing device so that the information processing device can be realized by the computer; and a computer-readable recording medium storing the control program therein.

Moreover, a method of the present invention for controlling an information processing device is a method for controlling an information processing device for displaying content, the method including the steps of: causing a superimposed object to be displayed so that the superimposed object is superimposed on the content (S10), the superimposed object containing an image in a range specified on the content which is displayed; and causing notification information to be displayed in a state where the superimposed object is temporarily hidden (S67), the notification information being indicative of a position of the range on the content. According to the configuration, an effect similar to that of the information processing device of the aspect 1 can be brought about.

The present invention is not limited to the embodiments, but can be variously altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention can suitably be used particularly in a smart phone, a tablet terminal, a PC (Personal Computer), or the like which includes a web browser.

### REFERENCE SIGNS LIST

1: Information processing device
12: Superimposed display processing section (superimposed displaying section)
23: Background tying section (information displaying section)
25: Keyword display section (keyword displaying section, keyword setting section)
26: Priority display processing section (sorting section)

1. An information processing device for displaying content, said information processing device comprising:
a superimposed displaying section for causing a superimposed object to be displayed so that the superimposed object is superimposed on the content, the superimposed object containing an image in a range specified on the content which is displayed; and
an information displaying section for causing notification information to be displayed in a state where the superimposed object is temporarily hidden, the notification information being indicative of a position of the range on the content.

2. The information processing device as set forth in claim 1, wherein:
the superimposed displaying section causes the superimposed object to be displayed again in response to an operation carried out with respect to the notification information.

3. The information processing device as set forth in claim 1, wherein:
the superimposed displaying section causes the superimposed object to be temporarily hidden when the superimposed object has been moved to an end part of a display screen; and
the notification information further indicates a position of the end part to which the superimposed object has been moved.

4. The information processing device as set forth in claim 1, further comprising:
a batch processing section for carrying out a certain process on one of a plurality of superimposed objects and on another one of the plurality of superimposed objects which is associated with the one of the plurality of superimposed objects, each of the plurality of superimposed objects being said superimposed object and being caused to be displayed by the superimposed displaying section.

5. The information processing device as set forth in claim 1, further comprising:
a keyword displaying section for causing a text string which is associated with the superimposed object to be displayed instead of the superimposed object.

6. The information processing device as set forth in claim 5, further comprising:
a keyword setting section for obtaining, from a line specified on the superimposed object, a text string to be associated with the superimposed object.

7. The information processing device as set forth in claim 1, further comprising:
a sorting section for sorting two or more of a plurality of superimposed objects in accordance with a predetermined priority, the two or more of the plurality of superimposed objects being associated with each other, and each of the plurality of superimposed objects being said superimposed object and being caused to be displayed by the superimposed displaying section.

8. A method for controlling an information processing device for displaying content, the method including the steps of:
causing a superimposed object to be displayed so that the superimposed object is superimposed on the content, the superimposed object containing an image in a range specified on the content which is displayed; and
causing notification information to be displayed in a state where the superimposed object is temporarily hidden, the notification information being indicative of a position of the range on the content.

9. (canceled)

10. A non-transitory computer-readable recording medium in which a program for causing a computer to carry out following steps is stored,
causing a superimposed object to be displayed so that the superimposed object is superimposed on the content, the superimposed object containing an image in a range specified on the content which is displayed; and
causing notification information to be displayed in a state where the superimposed object is temporarily hidden, the notification information being indicative of a position of the range on the content.
